(19) United States
(12) Patent Application Publication
(10) Pub. No.: US 2025/0215288 A1
(43) Pub. Date: Jul. 3, 2025

(54) PRESSURE-SENSITIVE ADHESIVE TAPE, COMPONENT, ELECTRONIC EQUIPMENT, AND VEHICLE

(71) Applicant: DIC Corporation, Tokyo (JP)

(72) Inventors: Takeshi Iwasaki, Saitama (JP); Sachi Muroi, Saitama (JP); Yusuke Takahasi, Saitama (JP); Hironobu Takizawa, Chiba (JP)

(73) Assignee: DIC Corporation, Tokyo (JP)

(21) Appl. No.: 18/978,464

(22) Filed: Dec. 12, 2024

(30) Foreign Application Priority Data
Dec. 28, 2023 (JP) 2023-222816

(51) Int. Cl. C09J 123/10; C09J 7/38; C09J 123/04

(52) U.S. Cl. CPC C09J 123/10; C09J 7/385; C09J 123/04; C09J 2203/354; C09J 2301/122; C09J 2301/302; C09J 2423/04; C09J 2423/10; C09J 2433/00

(57) ABSTRACT

A pressure-sensitive adhesive tape includes a base material and a pressure-sensitive adhesive layer laminated on at least one surface of the base material. The pressure-sensitive adhesive tape contains 5% by mass or greater and 95% by mass or less of an olefin-based resin having an olefin-based monomer unit with respect to a total amount (100% by mass) of the pressure-sensitive adhesive tape. The pressure-sensitive adhesive tape satisfies Relational Formula (1).

### TECHNICAL FIELD

One or more embodiments of the present invention relate to a pressure-sensitive adhesive tape, a component, electronic equipment, and a vehicle.

### BACKGROUND

A pressure-sensitive adhesive tape has excellent workability and high adhesion reliability, and thus has been widely used as bonding means in various industrial fields such as office automation (OA) equipment, IT products, household electric appliances, and automobiles for fixing components, temporarily fixing components, and labeling to display product information. A pressure-sensitive adhesive tape typically has pressure-sensitive adhesive strength (peeling strength) or tackiness (pressure-sensitive adhesiveness) as basic properties, but may be required to further have various other properties depending on the applications of the pressure-sensitive adhesive tape.

Further, in recent years, the concept of “sustainable development” has begun to be advocated with increased awareness of reducing the environmental burden such as reducing the adverse effects on the marine environment or ecosystems, which are caused by inappropriate disposal of used plastic products, used plastic containers, and the like. Therefore, awareness of recycling used products has raised not only in various industrial fields such as home appliances and automobiles, which use a pressure-sensitive adhesive tape, but also in the chemical industrial fields where the pressure-sensitive adhesive tape is produced. Used products are dismantled and each component of the products is removed in a case where various products such as home appliances or automobiles are recycled for the purpose of reducing the environmental burden, and a process of peeling the pressure-sensitive adhesive tape used as a label or to fix each component is required to be performed to remove each component. However, since the pressure-sensitive adhesive tape is provided in each place of the products, there is a demand for products to be more easily recycled.

For example, Japanese Unexamined Patent Application Publication No. 2000-309759 is an example of a technique for a pressure-sensitive adhesive tape intended for recycling. Japanese Unexamined Patent Application Publication No. 2000-309759 discloses a technique for a pressure-sensitive adhesive tape that enables recycling of a polyethylene pipe with the pressure-sensitive adhesive tape still attached thereto to be recycled as a high-quality polyethylene polymer.

However, in Japanese Unexamined Patent Application Publication No. 2000-309759, the tensile strength is examined as a property of a reproduced plastic material after the polyethylene pipe to which the pressure-sensitive adhesive tape is attached is recycled, but the level of the tensile strength that the reproduced plastic material exhibits as compared with the polyethylene pipe (polyethylene before being reproduced) is not disclosed, and thus questions remain as to whether the reproduced plastic material can exhibit desired properties.

### SUMMARY

Accordingly, one or more embodiments of the present invention is to provide a pressure-sensitive adhesive tape that can be recycled in a state of being attached to an adherend containing a thermoplastic resin and that has a small rate of a decrease in tensile strength of a reproduced plastic material after being recycled with the pressure-sensitive adhesive tape still attached thereto.

As a result of intensive examination conducted by the present inventors, it has been found that a pressure-sensitive adhesive tape which can be recycled in a state of being attached to an adherend containing a thermoplastic resin and has a small rate of a decrease in tensile strength of a reproduced plastic material after being recycled can be provided by satisfying a specific relational formula between the thermoplastic resin contained in the adherend, a base material, and the pressure-sensitive adhesive tape including a pressure-sensitive adhesive layer laminated on at least one surface of the base material, thereby completing one or more embodiments of the invention of the present application.

That is, the present disclosure is as follows.

[1] A recyclable pressure-sensitive adhesive tape including: a base material; and a pressure-sensitive adhesive layer laminated on at least one surface of the base material, in which the pressure-sensitive adhesive tape contains 5% by mass or greater and 95% by mass or less of an olefin-based resin having an olefin-based monomer unit with respect to a total amount (100% by mass) of the pressure-sensitive adhesive tape, and an adherend containing a thermoplastic resin, to which the pressure-sensitive adhesive tape is attached, and the pressure-sensitive adhesive tape satisfy Relational Formula (1).

$$\begin{matrix}[ Math . 1 ] & \\ 0.8 \leq {σ}_{b} / {σ}_{a} \leq 1.2 & ( 1 )\end{matrix}$$

(In Relational Formula (1), σₐ represents a tensile strength of the thermoplastic resin, and σ_{b} represents a tensile strength of a test piece prepared under the following conditions using the pressure-sensitive adhesive tape and the thermoplastic resin in the adherend.

### <Conditions for Preparing Test Piece>

A mixture of the pressure-sensitive adhesive tape and the thermoplastic resin is heated at a temperature 20° C. above a melting point of the thermoplastic resin, a resin pellet is prepared by a twin-screw extruder under conditions of a kneading speed of 350 rpm, a screw rotation speed of 300 rpm, and a discharge speed of 5 kg/h, and a multipurpose test piece type A obtained in conformity with JIS K 7139 using an injection molding machine is used as the test piece.)

[2] The recyclable pressure-sensitive adhesive tape according to [1], in which the adherend containing a thermoplastic resin, to which the pressure-sensitive adhesive tape is attached, and the pressure-sensitive adhesive tape further satisfy Relational Formula (2).

$$\begin{matrix}[ Math . 2 ] & \\ 0.8 \leq {σ}_{d} / {σ}_{c} \leq 1.2 & ( 2 )\end{matrix}$$

(In Relational Formula (2), σ_{c} represents a flexural stress of the thermoplastic resin, and σ_{d} represents a flexural stress of the test piece.)

[3] The recyclable pressure-sensitive adhesive tape according to [1] or [2], in which the base material contains the same resin as the thermoplastic resin or a resin having a partial chemical structure included in the thermoplastic resin.

[4] The recyclable pressure-sensitive adhesive tape according to any one of [1] to [3], in which the base material contains the olefin-based resin.

[5] The recyclable pressure-sensitive adhesive tape according to [4], in which the olefin-based resin includes a polyethylene resin or a polypropylene resin.

[6] The recyclable pressure-sensitive adhesive tape according to any one of [1] to [5], in which the base material is a foam base material.

[7] The recyclable pressure-sensitive adhesive tape according to any one of [1] to [6], in which the pressure-sensitive adhesive layer contains an acrylic pressure-sensitive adhesive.

[8] The recyclable pressure-sensitive adhesive tape according to any one of [1] to [7], in which the thermoplastic resin includes an olefin-based resin.

[9] The recyclable pressure-sensitive adhesive tape according to [8], in which the olefin-based resin includes a polyethylene resin or a polypropylene resin.

[10] The recyclable pressure-sensitive adhesive tape according to any one of [1] to [9], in which a content of the pressure-sensitive adhesive tape contained in the mixture is 10% by mass or less with respect to a total amount (100% by mass) of the mixture.

[11] The recyclable pressure-sensitive adhesive tape according to any one of [1] to [10], in which the pressure-sensitive adhesive tape contains one or two or more selected from the group consisting of an antioxidant, an ultraviolet absorbing agent, a heat stabilizer, and a resin reinforcing agent.

[12] A component which is formed of a thermoplastic resin, to which the recyclable pressure-sensitive adhesive tape according to any one of [1] to [11] is attached.

[13] Electronic equipment or a vehicle, which is formed of the component according to [12].

According to the present disclosure, it is possible to provide a pressure-sensitive adhesive tape that can be recycled in a state of being attached to an adherend containing a thermoplastic resin and that has a small rate of a decrease in tensile strength of a reproduced plastic material after being recycled with the pressure-sensitive adhesive tape still attached thereto.

### DETAILED DESCRIPTION

Hereinafter, one or more embodiments of the present invention (hereinafter, referred to as “present embodiment”) will be described in detail, but the present invention is not limited to the present embodiment.

### [Pressure-Sensitive Adhesive Tape]

According to the present disclosure, there is provided a recyclable pressure-sensitive adhesive tape including a base material and a pressure-sensitive adhesive layer laminated on at least one surface of the base material, in which the pressure-sensitive adhesive tape contains 5% by mass or greater and 95% by mass or less of an olefin-based resin having an olefin-based monomer unit with respect to a total amount (100% by mass) of the pressure-sensitive adhesive tape, and an adherend containing a thermoplastic resin, to which the pressure-sensitive adhesive tape is attached, and the pressure-sensitive adhesive tape satisfy Relational Formula (1).

$$\begin{matrix}[ Math . 1 ] & \\ 0.8 \leq {σ}_{b} / {σ}_{a} \leq 1.2 & ( 1 )\end{matrix}$$

(In Relational Formula (1), σₐ represents the tensile strength of the thermoplastic resin, and σ_{b} represents the tensile strength of a test piece prepared under the following conditions using the pressure-sensitive adhesive tape and the thermoplastic resin in the adherend.

### <Conditions for Preparing Test Piece>

A mixture of the pressure-sensitive adhesive tape and the thermoplastic resin is heated at a temperature 20° C. above the melting point of the thermoplastic resin, a resin pellet is prepared by a twin-screw extruder under conditions of a kneading speed of 350 rpm, a screw rotation speed of 300 rpm, and a discharge speed of 5 kg/h, and a multipurpose test piece type A obtained in conformity with JIS K 7139 using an injection molding machine is used as the test piece.)

In this manner, an effect that the rate of a decrease in tensile strength of the reproduced plastic material after material recycling of the pressure-sensitive adhesive tape, which can be recycled in a state of being attached to the adherend containing a thermoplastic resin, is small can be exhibited.

Further, the term “recycling” in the present specification denotes material recycling among the three aspects of (i) a method (material recycling) of recovering a used product or a product to be discarded (for example, a pre-consumer product), or a discarded product and using the product as a raw material (material), (ii) a method (thermal recycling) of incinerating a waste material with the assumption that the material will be disposed of in the final stage and using the heat generated from the combustion as energy, and (iii) a method (chemical recycling) of performing thermal decomposition or the like on waste plastics to produce oil or gas or to reduce the waste plastics in a blast furnace so that the waste plastics can be reused.

Further, a known extrusion molding machine can be used as the extrusion molding machine used to prepare a resin pellet, but a twin-screw extruder is preferable.

Hereinafter, the base material and the pressure-sensitive adhesive layer constituting the pressure-sensitive adhesive tape will be described after the description of the main configurations and the components of the pressure-sensitive adhesive tape of the present embodiment.

### (Structure of Pressure-Sensitive Adhesive Tape)

The pressure-sensitive adhesive tape of the present embodiment includes a base material and a pressure-sensitive adhesive layer on at least one surface of the base material. The pressure-sensitive adhesive layer may be present in direct contact with the base material, or may be laminated on one surface of the base material via a known easy adhesion treatment layer between the base material and the pressure-sensitive adhesive layer. Further, since the pressure-sensitive adhesive layer is not limited as long as the pressure-sensitive adhesive layer is laminated on at least one surface of the base material, the pressure-sensitive adhesive layer may be laminated only one surface or both surfaces of the base material. In a case of an aspect in which the pressure-sensitive adhesive layer is laminated on both surfaces, the pressure-sensitive adhesive layers provided on each surface of the base material may be the same as or different from each other.

Further, the pressure-sensitive adhesive layer may be present in direct contact with the base material such that the pressure-sensitive adhesive layer is provided on a part of at least one surface of the base material or at least one entire surface of the base material.

The aspect in which the pressure-sensitive adhesive layer is laminated on both surfaces is preferable as a preferable aspect of the pressure-sensitive adhesive tape of the present embodiment.

### (Main Material of Pressure-Sensitive Adhesive Tape)

The pressure-sensitive adhesive tape of the present embodiment contains 5% by mass or greater and 95% by mass or less of an olefin-based resin having an olefin-based monomer unit with respect to the total amount (100% by mass) of the pressure-sensitive adhesive tape.

In this manner, since the compatibility of the pressure-sensitive adhesive tape with an olefin-based resin material that has been usually widely used as a material of an adherend can be ensured, the pressure-sensitive adhesive tape can be recycled in a state of being attached to the adherend. From the viewpoint of exhibiting the dimension stability and the mechanical strength of the base material of the pressure-sensitive adhesive tape and the pressure-sensitive adhesive physical properties of the pressure-sensitive adhesive layer, it is preferable that the olefin-based resin be included in the material of the base material.

The upper limit of the content of the olefin-based resin may be 95% by mass or less, 90% by mass or less, 80% by mass or less, 70% by mass or less, 65% by mass or less, or 60% by mass or less with respect to the total amount (100% by mass) of the pressure-sensitive adhesive tape.

Meanwhile, the lower limit of the content of the olefin-based resin may be 5% by mass or greater, 7% by mass or greater, 10% by mass or greater, 13% by mass or greater, 15% by mass or greater, or 17% by mass or greater.

The preferable ranges of the content of the olefin-based resin can be obtained by appropriately combining the upper limits and the lower limits described above. For example, the content of the olefin-based resin may be 5% by mass or greater and 90% by mass or less, 10% by mass or greater and 80% by mass or less, or 15% by mass or greater and 70% by mass or less.

The upper limits and the lower limits of the content of the olefin-based resin can be optionally recombined.

Further, a method of calculating the content of the olefin-based resin with respect to the total amount (100% by mass) of the pressure-sensitive adhesive tape is as described in examples below.

Further, from the viewpoint of obtaining a base material, particularly a foam base material with excellent flexibility, followability, and mechanical strength, it is preferable that the pressure-sensitive adhesive tape contains a polyethylene resin and/or a polypropylene resin, or an ethylene-propylene copolymer resin as the olefin-based resin.

Further, it is preferable that an olefin-based resin be used as the material of the base material in the pressure-sensitive adhesive tape of the present embodiment as described below.

### (Thermoplastic Resin)

The pressure-sensitive adhesive tape of the present embodiment can be attached to the adherend containing a thermoplastic resin. In a case where the adherend containing a thermoplastic resin is used as an attachment target of the pressure-sensitive adhesive tape of the present embodiment, the adherend containing a thermoplastic resin is more easily melted by heat and is likely to be re-molded into a desired shape, which is preferable from the viewpoint of the material recycling.

Examples of the thermoplastic resin include thermoplastic polyurethane (TPU); a polycarbonate (PC) resin; a vinyl chloride resin such as polyvinyl chloride (PVC) or a vinyl chloride-vinyl acetate copolymer resin; an acrylic resin such as polyacrylic acid, polymethacrylic acid, polymethyl acrylate, polymethyl methacrylate (PMMA), or polyethyl methacrylate; a polyester resin such as polyethylene terephthalate (PET), polybutylene terephthalate, polytrimethylene terephthalate, polyethylene naphthalate, or polybutylene naphthalate; a polystyrene resin such as polystyrene (PS), imide-modified polystyrene, an acrylonitrile/butadiene/styrene (ABS) resin, an imide-modified ABS resin, a styrene/acrylonitrile copolymer (SAN) resin, or an acrylonitrile/ethylene-propylene-diene styrene (AES) resin, an olefin-based resin such as a polyethylene (PE) resin, a polypropylene (PP) resin, or a cycloolefin resin; a polyacetal (POM) resin; a cellulose resin such as nitrocellulose or cellulose acetate; a silicone resin; and a fluorine resin.

It is preferable that the thermoplastic resin which is the material of the adherend serving as a target to which the pressure-sensitive adhesive tape of the present embodiment is attached and the material constituting the pressure-sensitive adhesive tape have a common chemical structure or the material constituting the pressure-sensitive adhesive tape and the main chain of the thermoplastic resin have the same chemical structure. In this manner, since the pressure-sensitive adhesive tape and the thermoplastic resin are compatible with each other, a rate of a decrease in tensile strength of the material after material recycling in the reproduced plastic material is further reduced.

As the thermoplastic resin of the present embodiment, an olefin-based resin such as a polyethylene (PE) resin, a polypropylene (PP) resin, or a cycloolefin resin is preferable, and a polyethylene (PE) resin or a polypropylene (PP) resin is more preferable. In this manner, an olefin-based resin with excellent mechanical properties can be selected as the material constituting the pressure-sensitive adhesive tape, particularly the material of the base material, which is preferable from the viewpoint that the rate of a decrease in tensile strength of the material after material recycling in the reproduced plastic material is further reduced and that the reproduced plastic material is easily used in the same applications as the applications of the material before being recycled.

### (Adherend)

The adherend of the present embodiment is not particularly limited as long as the adherend contains a thermoplastic resin, and has been used in various industrial fields such as office automation (OA) equipment, IT products, household electric appliances, and automobiles, and examples of the adherend include housings of such products, batteries incorporated in such products, and components such as electronic components and structural components. Specifically, the adherend may be any of electric/electronic equipment and components thereof, OA equipment and components thereof, information terminal equipment and components thereof, machine components, household electric appliances and components thereof, moving objects (aircrafts and railway vehicles) and components thereof, vehicle components (automobile interiors and exteriors), building members, various containers and components thereof, leisure goods/miscellaneous goods and components thereof, and lighting equipment and components thereof.

Further, the pressure-sensitive adhesive tape of the present embodiment can fix or temporarily fix the adherend. In addition, the pressure-sensitive adhesive tape itself of the present embodiment can also be used as a label that displays product information and the like.

The adherend of the present embodiment is not particularly limited as long as the content of the thermoplastic resin with respect to the total amount of the adherend satisfies the required performance of the adherend, but it is preferable that the adherend contain a greater amount of thermoplastic resin, and thus the content thereof may be, for example, 50% by mass or greater or 60% by mass or greater.

Further, the adherend of the present embodiment may be formed of only a thermoplastic resin.

### (Relational Formula (1))

In the pressure-sensitive adhesive tape of the present embodiment, the adherend containing a thermoplastic resin, to which the pressure-sensitive adhesive tape is attached, and the pressure-sensitive adhesive tape satisfy Relational Formula (1).

$$\begin{matrix}[ Math . 1 ] & \\ 0.8 \leq {σ}_{b} / {σ}_{a} \leq 1.2 & ( 1 )\end{matrix}$$

(In Relational Formula (1), σₐ represents the tensile strength (MPa) of the thermoplastic resin, and σ_{b} represents the tensile strength (MPa) of a test piece prepared under the following conditions using the pressure-sensitive adhesive tape and the thermoplastic resin in the adherend.

### <Conditions for Preparing Test Piece>

A mixture of the pressure-sensitive adhesive tape and the thermoplastic resin is heated at a temperature 20° C. above the melting point of the thermoplastic resin, a resin pellet is prepared by a twin-screw extruder under conditions of a kneading speed of 350 rpm, a screw rotation speed of 300 rpm, and a discharge speed of 5 kg/h, and a multipurpose test piece type A obtained in conformity with JIS K 7139 using an injection molding machine is used as the test piece.)

In this manner, a pressure-sensitive adhesive tape which has a small rate of a decrease in tensile strength in the reproduced plastic material after being recycled and has excellent material recycling properties can be provided.

In a case where σ_{b}/σₐ, which indicates a ratio of the tensile strength (σ_{b}) of the resin material reproduced from the mixture of the pressure-sensitive adhesive tape and the thermoplastic resin to the tensile strength (σₐ) of the thermoplastic resin which is a material of the adherend to which the pressure-sensitive adhesive tape is attached, is in a range of 0.8 to 1.2, this denotes that the mechanical properties of the thermoplastic resin which is the material before being kneaded and melted (before being recycled) and the mechanical properties of the alloy resin of the pressure-sensitive adhesive tape and the thermoplastic resin, which is the material after being kneaded and melted (after being recycled) are similar to each other (within ±20%). More specifically, in consideration of the meaning of the tensile strength, which is the maximum stress that a material can withstand in a series of processes of elastic deformation, plastic deformation, fraction, and rupture, the state where the tensile strengths of both the resins are similar to each other indicates that the pressure-sensitive adhesive tape and the thermoplastic resin in the alloy resin after being recycled are compatible with each other.

Therefore, in a case where the alloy resin of the pressure-sensitive adhesive tape and the thermoplastic resin, which is the material after being recycled is morphologically described, since a so-called pressure-sensitive adhesive tape-derived component and a so-called thermoplastic resin-derived component in the alloy resin are compatible with each other, the alloy resin is considered to exhibit the tensile strength equivalent to the tensile strength of the thermoplastic resin which is the material before being kneaded and melted (before being recycled). In this manner, an effect that the rate of a decrease in tensile strength of the reproduced plastic material after being recycled is small is considered to be exhibited.

σ_{b}/σₐ, which indicates a ratio of the tensile strength (σ_{b}) of the resin material reproduced from the mixture of the pressure-sensitive adhesive tape and the thermoplastic resin to the tensile strength (σₐ) of the thermoplastic resin which is a material of the adherend to which the pressure-sensitive adhesive tape is attached, is preferably in a range of 0.88 to 1.16 and more preferably in a range of 0.92 to 1.1.

The content of the pressure-sensitive adhesive tape contained in the mixture of the pressure-sensitive adhesive tape and the thermoplastic resin can be optionally set depending on the aspect of use. For example, the content of the pressure-sensitive adhesive tape contained in the mixture of the pressure-sensitive adhesive tape and the thermoplastic resin may be 10% by mass or less with respect to the total amount of the mixture. In a case where the content thereof is set to 10% by mass or less, the proportion of the thermoplastic resin in the recycled resin is large, the recycled resin is likely to be used as a mono-material. Further, the upper limit of the content of the pressure-sensitive adhesive tape contained in the mixture may be 9.5% by mass or less, 7.5% by mass or less, 6.5% by mass or less, 5.3% by mass or less, 4.1% by mass or less, or 3.5% by mass or less. Further, the lower limit of the content of the pressure-sensitive adhesive tape contained in the mixture may be greater than 0% by mass, 0.013% by mass or greater, 0.1% by mass or greater, 0.3% by mass or greater, 0.8% by mass or greater, or 1% by mass or greater.

It is preferable that the content of the pressure-sensitive adhesive tape contained in the mixture of the pressure-sensitive adhesive tape and the thermoplastic resin is in the above-described ranges from the viewpoint that Gb/Ga, which indicates the ratio of the tensile strength (σ_{b}) of the resin material reproduced from the mixture of the pressure-sensitive adhesive tape and the thermoplastic resin to the tensile strength (σₐ) of the thermoplastic resin which is a material of the adherend to which the pressure-sensitive adhesive tape is attached is in the above-described preferable ranges of one or more embodiments of the present invention, and thus degradation of the physical properties after recycling is suppressed.

A method of measuring the tensile strength (MPa) of the thermoplastic resin and the tensile strength (MPa) of the test piece obtained from the mixture of the pressure-sensitive adhesive tape and the thermoplastic resin is performed using a tensile tester (manufactured by Shimadzu Corporation) under measurement conditions of a distance of 115 mm between gripping jigs, a reference line spacing of 75 mm, a test speed of 50 mm/min, a temperature of 23° C., and a humidity of 50% RH in conformity with JIS K 7161-1 as described in the examples below.

### (Relational Formula (2))

In the pressure-sensitive adhesive tape of the present embodiment, it is preferable that the adherend containing a thermoplastic resin, to which the pressure-sensitive adhesive tape is attached, and the pressure-sensitive adhesive tape further satisfy Relational Formula (2).

$$\begin{matrix}[ Math . 2 ] & \\ 0.8 \leq {σ}_{d} / {σ}_{c} \leq 1.2 & ( 2 )\end{matrix}$$

(In Relational Formula (2), σ_{c} represents a flexural strength (MPa) of the thermoplastic resin, and σ_{d} represents a flexural strength (MPa) of the test piece.)

In this manner, a pressure-sensitive adhesive tape which has a small rate of a decrease in tensile strength in the reproduced plastic material after being recycled and has excellent material recycling properties can be provided.

In a case where σ_{d}/σ_{c}, which indicates a ratio of the flexural strength (σ_{d}) of the resin material reproduced from the mixture of the pressure-sensitive adhesive tape and the thermoplastic resin to the flexural strength (σ_{c}) of the thermoplastic resin which is a material of the adherend to which the pressure-sensitive adhesive tape is attached, is in a range of 0.8 to 1.2, this denotes that the mechanical properties of the thermoplastic resin which is the material before being kneaded and melted (before being recycled) and the mechanical properties of the alloy resin of the pressure-sensitive adhesive tape and the thermoplastic resin, which is the material after being kneaded and melted (after being recycled) are similar to each other (within ±20%) as in the case of the tensile strength, and thus the pressure-sensitive adhesive tape and the thermoplastic resin in the alloy resin after being recycled are in a state of being compatible with each other. Therefore, in a case where the alloy resin of the pressure-sensitive adhesive tape and the thermoplastic resin, which is the material after being recycled is morphologically described, since a so-called pressure-sensitive adhesive tape-derived component and a so-called thermoplastic resin-derived component in the alloy resin are compatible with each other, the alloy resin is considered to exhibit the flexural strength equivalent to the flexural strength of the thermoplastic resin which is the material before being kneaded and melted (before being recycled). In this manner, an effect that the rate of a decrease in tensile strength of the reproduced plastic material after being recycled is small is considered to be exhibited.

σ_{d}/σ_{c}, which indicates a ratio of the flexural strength (σ_{d}) of the resin material reproduced from the mixture of the pressure-sensitive adhesive tape and the thermoplastic resin to the flexural strength (σ_{c}) of the thermoplastic resin which is a material of the adherend to which the pressure-sensitive adhesive tape is attached, is preferably in a range of 0.88 to 1.16 and more preferably in a range of 0.92 to 1.1.

The content of the pressure-sensitive adhesive tape contained in the mixture of the pressure-sensitive adhesive tape and the thermoplastic resin can be optionally set depending on the aspect of use when Relational Formula (2) is calculated. For example, the content of the pressure-sensitive adhesive tape contained in the mixture of the pressure-sensitive adhesive tape and the thermoplastic resin may be 10% by mass or less with respect to the total amount of the mixture. In a case where the content thereof is set to 10% by mass or less, the proportion of the thermoplastic resin in the recycled resin is large, the recycled resin is likely to be used as a mono-material. Further, the upper limit of the content of the pressure-sensitive adhesive tape contained in the mixture may be 9.5% by mass or less, 7.5% by mass or less, 6.5% by mass or less, 5.3% by mass or less, 4.1% by mass or less, or 3.5% by mass or less. Further, the lower limit of the content of the pressure-sensitive adhesive tape contained in the mixture may be greater than 0% by mass, 0.013% by mass or greater, 0.1% by mass or greater, 0.3% by mass or greater, 0.8% by mass or greater, or 1% by mass or greater.

It is preferable that the content of the pressure-sensitive adhesive tape contained in the mixture of the pressure-sensitive adhesive tape and the thermoplastic resin be in the above-described ranges from the viewpoint that σ_{d}/σ_{c}, which indicates the ratio of the flexural strength (σ_{d}) of the resin material reproduced from the mixture of the pressure-sensitive adhesive tape and the thermoplastic resin to the flexural strength (σ_{c}) of the thermoplastic resin which is a material of the adherend to which the pressure-sensitive adhesive tape is attached is in the above-described preferable ranges of one or more embodiments of the present invention, and thus degradation of the physical properties after recycling is suppressed.

A method of measuring the flexural strength (MPa) of the thermoplastic resin and the flexural strength (MPa) of the test piece obtained from the mixture of the pressure-sensitive adhesive tape and the thermoplastic resin is performed by carrying out a three-point flexural test using a tensile tester (manufactured by Shimadzu Corporation) under measurement conditions of a test speed of 2 mm/min, a distance of 64 mm between lower fulcrum, a temperature of 23° C., and a humidity of 50% RH in conformity with JIS K 7171 as described in the examples below, and the flexural strength (maximum flexural stress, MPa) and the flexural strain at flexural strength (%) are measured.

In the present embodiment, requirements that tend to satisfy Relational Formula (1) include the following items (I-1) to (IX-1).

(I-1) It is preferable that the base material or the pressure-sensitive adhesive layer of the pressure-sensitive adhesive tape contains the same resin as the thermoplastic resin or a resin having a partial chemical structure included in the thermoplastic resin and more preferable that the base material contain the same resin as the thermoplastic resin or a resin having a partial chemical structure included in the thermoplastic resin.

(II-1) It is preferable that the base material or the pressure-sensitive adhesive layer of the pressure-sensitive adhesive tape be formed of an olefin-based resin such as a polyethylene (PE) resin, a polypropylene (PP) resin, or a cycloolefin resin or contain these resins. Among these, a polyethylene (PE) resin or a polypropylene (PP) resin is more preferable.

(III-1) It is preferable that the base material constituting the pressure-sensitive adhesive tape be formed of an olefin-based resin such as a polyethylene (PE) resin, a polypropylene (PP) resin, or a cycloolefin resin or contain these resins. Among these, a polyethylene (PE) resin, a polypropylene (PP) resin, or an ethylene-propylene copolymer resin is more preferable.

(IV-1) As the thermoplastic resin, an olefin-based resin such as a polyethylene (PE) resin, a polypropylene (PP) resin, or a cycloolefin resin is preferable. Among these, a polyethylene (PE) resin or a polypropylene (PP) resin is more preferable.

(V-1) It is preferable that the pressure-sensitive adhesive composition constituting the pressure-sensitive adhesive layer of the pressure-sensitive adhesive tape have a weight-average molecular weight of 400000 to 1600000.

(VI-1) It is preferable that the pressure-sensitive adhesive layer of the pressure-sensitive adhesive tape contain a rosin-based resin, a polymerized rosin-based resin, a polymerized rosin ester-based resin, a rosin phenol-based resin, a stabilized rosin ester-based resin, a disproportionated rosin ester-based resin, a hydrogenated rosin ester-based resin, a terpene-based resin, a terpene phenol-based resin, a petroleum-based resin, and a (meth)acrylate-based resin.

(VII-1) It is preferable that the pressure-sensitive adhesive layer of the pressure-sensitive adhesive tape be formed of an acrylic pressure-sensitive adhesive composition or a rubber-based pressure-sensitive adhesive composition.

(VIII-1) It is preferable that the content of the olefin-based resin be 5% by mass or greater and 90% by mass or less with respect to the total amount (100% by mass) of the pressure-sensitive adhesive tape.

(IX-1) It is preferable that the proportion of the pressure-sensitive adhesive tape be 10% by mass or less with respect to the total mass of the mixture of the pressure-sensitive adhesive tape and the thermoplastic resin.

The compatibility between the thermoplastic resin and the pressure-sensitive adhesive tape is improved by satisfying the conditions of the above-described items (I-1) to (IX-1). Further, since the mixture of the pressure-sensitive adhesive tape and the thermoplastic resin shows the degree of crystallinity (molecular orientation properties) and the intermolecular interaction which are similar to those of the thermoplastic resin, σ_{b}/σₐ, which indicates a ratio of the tensile strength (σ_{b}) of the resin material reproduced from the mixture of the pressure-sensitive adhesive tape and the thermoplastic resin to the tensile strength (σₐ) of the thermoplastic resin which is a material of the adherend to which the pressure-sensitive adhesive tape is attached, is in the preferable ranges of one or more embodiments of the present invention, which is preferable in terms that degradation of the physical properties after recycling is suppressed.

Similarly, in the present embodiment, requirements that tend to satisfy Relational Formula (2) include the following items (I-2) to (IX-2).

(I-2) It is preferable that the base material or the pressure-sensitive adhesive layer of the pressure-sensitive adhesive tape contains the same resin as the thermoplastic resin or a resin having a partial chemical structure included in the thermoplastic resin and more preferable that the base material contain the same resin as the thermoplastic resin or a resin having a partial chemical structure included in the thermoplastic resin.

(II-2) It is preferable that the base material or the pressure-sensitive adhesive layer of the pressure-sensitive adhesive tape be formed of an olefin-based resin such as a polyethylene (PE) resin, a polypropylene (PP) resin, or a cycloolefin resin or contain these resins. Among these, a polyethylene (PE) resin, a polypropylene (PP) resin, or an ethylene-propylene copolymer resin is more preferable.

(III-2) It is preferable that the base material constituting the pressure-sensitive adhesive tape be formed of an olefin-based resin such as a polyethylene (PE) resin, a polypropylene (PP) resin, or a cycloolefin resin or contain these resins. Among these, a polyethylene (PE) resin, a polypropylene (PP) resin, or an ethylene-propylene copolymer resin is more preferable.

(IV-2) As the thermoplastic resin, an olefin-based resin such as a polyethylene (PE) resin, a polypropylene (PP) resin, or a cycloolefin resin is preferable. Among these, a polyethylene (PE) resin or a polypropylene (PP) resin is more preferable.

(V-2) It is preferable that the pressure-sensitive adhesive composition constituting the pressure-sensitive adhesive layer of the pressure-sensitive adhesive tape have a weight-average molecular weight of 400000 to 1600000.

(VI-2) It is preferable that the pressure-sensitive adhesive layer of the pressure-sensitive adhesive tape contain a rosin-based resin, a polymerized rosin-based resin, a polymerized rosin ester-based resin, a rosin phenol-based resin, a stabilized rosin ester-based resin, a disproportionated rosin ester-based resin, a hydrogenated rosin ester-based resin, a terpene-based resin, a terpene phenol-based resin, a petroleum-based resin, and a (meth)acrylate-based resin.

(VII-2) It is preferable that the pressure-sensitive adhesive layer of the pressure-sensitive adhesive tape be formed of an acrylic pressure-sensitive adhesive composition or a rubber-based pressure-sensitive adhesive composition.

(VIII-2) It is preferable that the content of the olefin-based resin be 5% by mass or greater and 90% by mass or less with respect to the total amount (100% by mass) of the pressure-sensitive adhesive tape.

(IX-2) It is preferable that the proportion of the pressure-sensitive adhesive tape be 10% by mass or less with respect to the total mass of the mixture of the pressure-sensitive adhesive tape and the thermoplastic resin.

The compatibility between the thermoplastic resin and the pressure-sensitive adhesive tape is improved by satisfying the conditions of the above-described items (I-2) to (IX-2). Further, since the mixture of the pressure-sensitive adhesive tape and the thermoplastic resin shows the degree of crystallinity (molecular orientation properties) and the intermolecular interaction which are similar to those of the thermoplastic resin, σ_{c}/σ_{c}, which indicates a ratio of the flexural strength (σ_{d}) of the resin material reproduced from the mixture of the pressure-sensitive adhesive tape and the thermoplastic resin to the flexural strength (σ_{c}) of the thermoplastic resin which is a material of the adherend to which the pressure-sensitive adhesive tape is attached, is in the preferable ranges of one or more embodiments of the present invention, which is preferable in terms that degradation of the physical properties after recycling is suppressed.

It is preferable that the pressure-sensitive adhesive tape of the present embodiment be produced from a biomass raw material. Specifically, the lower limit of the biomass carbon content (%) in the pressure-sensitive adhesive tape of the present embodiment may be 10% or greater, 13% or greater, 15% or greater, 17% or greater, 20% or greater, 25% or greater, or 35% or greater with respect to all carbon atoms in the pressure-sensitive adhesive tape. Meanwhile, the upper limit of the biomass carbon content (%) may be, in order of preference, 100% or less, 90% or less, 80% or less, 73% or less, or 68% or less. The upper limits and the lower limits can be optionally combined. For example, the biomass carbon content (%) in the pressure-sensitive adhesive tape may be 10% or greater, in a range of 10% or greater and 90% or less, in a range of 20% or greater and 80% or less, or in a range of 22% or greater and 73% or less. In a case where the biomass carbon content (%) in the pressure-sensitive adhesive tape is 10% or greater, the effect of reducing the environmental burden can be exhibited.

In the present specification, the expression “biomass carbon content (%)” is a correction value obtained by multiplying the radiocarbon (¹⁴C) content ratio (pMC %) by 0.93, which is a correction proportion, and the correction value is regarded as 100% in a case where the correction value is 100% or greater.

It is preferable that the thermoplastic resin in the adherend of the present embodiment be produced from a biomass raw material. Specifically, the lower limit of the biomass carbon content (%) in the thermoplastic resin of the present embodiment may be 10% or greater, 13% or greater, 15% or greater, 17% or greater, 20% or greater, 25% or greater, or 35% or greater with respect to all carbon atoms in the pressure-sensitive adhesive tape. Meanwhile, the upper limit of the biomass carbon content (%) may be 100% or less, 90% or less, 80% or less, 73% or less, or 68% or less.

The biomass carbon content (%) of the pressure-sensitive adhesive tape according to the present embodiment can be set to be in a predetermined range by, for example, using optional components of the material of the base material and/or the pressure-sensitive adhesive layer (pressure-sensitive adhesive composition) as the material derived from biomass. For example, it is preferable that an olefin-based monomer unit (for example, ethylene) as the material of the base material be used as a biomass raw material.

As an example in which ethylene is used as a biomass raw material, ethylene derived from a biomass raw material can be synthesized by a known method from biosynthetic pathways (1) to (3) described below or bioethanol.

Further, polypropylene can be synthesized from the ethylene by a known method (see C. W. Ingram, R. J. Lancashire, Catal. Lett., 31, 395 (1995)).

[Chem. 1]

L-Met→SAM→ACC→ethylene(plant) (1)

L-Met→KMBA→ethylene (microorganism) (2)

L-Glu→AKG→ethylene (microorganism) (3)

L-Met: methionine, SAM: S-adenosylmethionine, ACC: 1-aminocyclopropane-1-carboxylic acid, KMBA: 2-keto-4-thiomethylbutyric acid, AKG: α-ketoglutaric acid, L-Glu: glutamic acid

In the present specification, the radiocarbon (¹⁴C) content ratio (pMC %) denotes the carbon concentration (mass ratio) of the biomass-derived components, and is related to a so-called biomass blending ratio. More specifically, the radiocarbon (¹⁴C) content ratio is a value of the radiocarbon (¹⁴C) content ratio obtained by the method of measuring the radiocarbon (¹⁴C) in conformity with ASTM-D-6866 (particularly, the ASTM D6866 B method). The radiocarbon (¹⁴C) is known to have a property of radioactively decaying into nitrogen (¹⁴N) with a half-life of 5730 years. Further, the radiocarbon (¹⁴C) constantly generated in an extremely small amount on earth by an action of cosmic rays pouring from space is oxidized to carbon dioxide ¹⁴CO₂, diffused into the atmosphere, incorporated into plants and animals in the process of the food chain, and disappears according to the half-life while circulating in the environment through the food chain. Therefore, the method of measuring the radiocarbon (¹⁴C) uses that fossil fuels contain substantially no radiocarbon (¹⁴C) and that the carbon derived from biomass (or organisms) absorbs radiocarbon (¹⁴C) in the atmosphere for a growth time period, and is a method of estimating the radiocarbon (¹⁴C) content ratio (pMC %) from the radiocarbon (¹⁴C) ratio in the carbon contained in the biomass material (or organisms). Therefore, as the value of the radiocarbon (¹⁴C) content ratio (pMC %) increases, the amount of fossil fuel to be used decreases, and the effect of reducing the environmental burden can be exhibited. Accordingly, the value of the radiocarbon (¹⁴C) content ratio (pMC %) is related to an index (biomass carbon content (%)) showing the blending ratio of biomass, which is a renewable organic resource derived from organisms.

The proportion of carbon derived from biomass can be calculated by measuring the proportion of radiocarbon (¹⁴C) contained in all carbon atoms of the thermoplastic resin in the pressure-sensitive adhesive tape of the present embodiment or the adherend. In the present disclosure, graphite for measurement is prepared from the pressure-sensitive adhesive tape or the thermoplastic resin by a known method, accelerator mass spectrometry (AMS) is performed, and the radiocarbon (¹⁴C) content ratio (pMC %) in the pressure-sensitive adhesive tape or the adherend is calculated by Equation (X). Thereafter, the value of the radiocarbon (¹⁴C) content ratio (pMC %) is multiplied by 0.93 using Equation (Y), and the value taking into account the influence of the atmospheric nuclear testing during a period from 1950 to the present day is defined as the biomass carbon content (%) of the pressure-sensitive adhesive tape or the adherend.

$$Equation ( X )$$

$$Radiocarbon ( {}^{14} C ) content ratio ( pMC \% ) = [ \text{} \{ radiocarbon ( {}^{14} C ) of thermoplastic resin in pressure - sensitive adhesive tape or adherend \div carbon ( {}^{12} C ) contained in thermoplastic resin in pressure - sensitive adhesive tape or adherend \} / \{ radiocarbon ( {}^{14} C ) of reference material / carbon ( {}^{12} C ) of reference material \} \times 100$$

(In Equation (X), a material obtained by converting oxalic acid (SRM4990C), supplied as a reference material using a chronological measurement method by National Institute of Standard and Technology, to graphite using the same pretreatment method as that for the graphite for measurement described in the section of the examples below is used as the reference material.)

$$Equation ( Y )$$

$$biomass carbon content ( \% ) = radiocarbon ( {}^{14} C ) content ratio ( pMC \% ) \times 0.93$$

Further, the radiocarbon (¹⁴C) in an amount of about 1.5 times the normal amount is observed by the radiocarbon (¹⁴C) artificially injected into the atmosphere due to the influence of the atmospheric nuclear testing since 1950. However, the amount of radiocarbon has been gradually decreasing over time, and the current value thereof is about 107.5 (pMC %). Therefore, in the present disclosure, the value obtained by multiplying the radiocarbon (¹⁴C) content ratio (pMC %) by 0.93 (=100/107.5) is defined as the biomass carbon content (%) similarly to the ASTM D6866 standard. Here, a value of 100% or greater may be calculated in some cases even when a method using Equation (Y) is employed. Therefore, in the present disclosure, similarly to the ASTM standard, the value of the biomass carbon content (%) is regarded as 100% in a case where the value is 100% or greater.

In the present embodiment, the concentration of the radiocarbon (¹⁴C) is measured by accelerator mass spectrometry (AMS) that combines a tandem accelerator and a mass spectrometer using a method of physically separating isotopes (specific examples thereof include ¹²C, ¹³C, and ¹⁴C) of carbon atoms in a sample to be analyzed with an accelerator based on a difference in weight between the atoms and measuring the amount of each atom of the isotopes to be present.

Further, the sample to be analyzed is the thermoplastic resin in the pressure-sensitive adhesive tape or the adherend, and the sample is required to be subjected to a pretreatment. Specifically, the carbon contained in the sample is subjected to an oxidation treatment and entirely converted to carbon dioxide. Further, the obtained carbon dioxide is separated into water and nitrogen, subjected to a reduction treatment, and converted to graphite which is solid carbon. The accelerator mass spectrometry of the present embodiment employs a method of using the obtained graphite as a sample for measurement, irradiating the sample with positive ions such as Cs⁺ to generate negative carbon ions, accelerating the carbon ions using a 3MV tandem accelerator, charge-converting from the negative ions to positive ions, separating traveling orbits of ¹²C³⁺, ¹³C³⁺, and ¹⁴C³⁺ using a mass analysis electromagnet, and measuring ¹⁴C³⁺ with an electrostatic analyzer.

Further, the carbon isotopes ¹²C, ¹³C, and ¹⁴C contained in the graphite obtained from the pretreated sample are accelerated at the same speed, and the flight paths thereof are bent by the electric field of the mass analysis electromagnet. In this case, ¹²C and ¹³C fly on the inside and the heaviest ¹⁴C flies on the outermost side of the bent portion. Further, since ¹²C and ¹³C are present in large numbers, ¹²C and ¹³C are counted as the electric current using a Faraday cup detector, and ¹⁴C is counted one by one using an ionization chamber ion detector.

Hereinafter, the base material and the pressure-sensitive adhesive layer constituting the pressure-sensitive adhesive tape will be described.

### (Base Material)

The pressure-sensitive adhesive tape of the present embodiment includes a base material as a carrier of the pressure-sensitive adhesive layer. Further, in a case where the pressure-sensitive adhesive tape of the present embodiment is a double-sided pressure-sensitive adhesive tape having pressure-sensitive adhesive layers on both surfaces of the base material, the base material functions as core.

The base material of the present embodiment is not particularly limited, and examples thereof include a resin base material, a foam base material, nonwoven fabrics, a rubber sheet, woven fabrics, paper, glass, metal foil, and composites thereof. The resin base material is a non-foamed or non-porous resin film or sheet and distinguished from nonwoven fabrics or a foam base material.

Among these, in a case of emphasizing the viewpoint that the adhesiveness can be highly exhibited between layers of the pressure-sensitive adhesive layer and the base material, coloring is easily carried out, and the shielding properties and the design properties due to the color of the base material are likely to be exhibited, it is preferable that the base material be a resin base material. Meanwhile, in a case of emphasizing the viewpoint of having excellent adhesiveness to the adherend and suitably following to the adherend particularly having an uneven shape or a rough surface so that excellent adhesiveness to the adherend is exhibited, it is preferable that the base material be a foam base material.

It is preferable that the base material of the present embodiment contains the same resin as the thermoplastic resin contained in the adherend or a resin having a partial chemical structure included in the thermoplastic resin.

In this manner, it is possible to provide a pressure-sensitive adhesive tape that can be recycled in a state of being attached to an adherend containing a thermoplastic resin and that has a small rate of a decrease in tensile strength of a reproduced plastic material after being recycled with the pressure-sensitive adhesive tape.

The base material may be colorless (so-called colorless base material) or colored (so-called colored base material). The colored base material may be formed, for example, by performing printing or coating the surface of a resin film or the like to provide a colored layer or by allowing the resin material constituting the resin film or the like to contain a coloring agent.

The base material may have a primer layer on the surface thereof for the purpose of improving the adhesiveness to the pressure-sensitive adhesive layer. Examples of the surface treatment include a roughening treatment using a sandblasting method, a solvent treatment method, or the like, a corona discharge treatment, an atmospheric pressure plasma treatment, a chromic acid treatment, a flame treatment, a hot air treatment, an ozone/ultraviolet irradiation treatment, an oxidation treatment, and an anchor coat treatment. Further, the surface of the base material may be subjected to an antistatic treatment.

### <Resin Base Material>

A sheet or a film obtained by using, for example, a polyester resin such as polyester, polyethylene terephthalate, polyethylene naphthalate, or polybutylene terephthalate, an olefin-based resin (a polyethylene resin or a polypropylene resin), polyacrylate, polyvinyl chloride, polypropylene ethylene vinyl alcohol, a polyurethane resin, a polyamide resin, or a polyimide resin can be used as the resin base material of the present embodiment. A base material obtained by being subjected to a corona treatment, an anchor coat treatment, or the like can be used as the base material for the purpose of improving anchoring properties of the pressure-sensitive adhesive layer. In a case where the base material of the present embodiment is a resin base material, an olefin-based resin (a polyethylene resin, a polypropylene resin, or an ethylene-propylene copolymer resin) is preferable.

The average thickness of the resin base material of the present embodiment can be appropriately set depending on the applications of the pressure-sensitive adhesive tape. The average thickness thereof may be in a range of 1 to 150 μm, in a range of 2 to 120 μm, or in a range of 3 to 100 μm. It is preferable that the thickness of the base material be in the above-described ranges from the viewpoint that the pressure-sensitive adhesive tape is likely to follow to the distortion of the adherend and high adhesive strength is likely to be obtained.

A base material provided with a primer layer and subjected to a surface treatment such as a surface roughening treatment using a sandblasting method, a solvent treatment method, or the like, a corona discharge treatment, a chromic acid treatment, a flame treatment, a hot air treatment, an ozone treatment, an ultraviolet irradiation treatment, or an oxidation treatment can be used as the resin base material for the purpose of further improving the adhesiveness to the pressure-sensitive adhesive layer.

Examples of a method of producing the resin base material of the present embodiment include a casting method using extrusion molding, a uniaxial stretching method, a sequential secondary stretching method, a simultaneous biaxial stretching method, an inflation method, a tube method, a calendar method, and a solution method. Among these, a production method such as a casting method using extrusion molding, a uniaxial stretching method, a sequential secondary stretching method, a simultaneous biaxial stretching method, an inflation method, or a tube method can be suitably used, and the production method may be selected according to the mechanical strength required for the resin base material of the present embodiment.

The resin base material may have a single layer structure or a multi-layer structure having two, three, or more layers. In a case of the multi-layer structure, it is preferable that at least one layer has the resin composition described above from the viewpoint that the required mechanical properties are likely to be exhibited.

### <Foam Base Material>

It is preferable that the base material of the present embodiment be a foam base material. In this manner, the base material has excellent adhesiveness to the adherend and also has excellent adhesiveness particularly to the adherend having an uneven shape or a rough surface by suitably following to the adherend.

It is preferable that an independent foam structure is used as the foam structure of the foam base material according to the present embodiment from the viewpoint of effectively preventing water from entering a cut surface of the foam base material. The shape of the foam forming the independent foam structure is not particularly limited, but an independent foam having a shape in which the average foam diameter of the foam in the flow direction, the width direction, or both directions is greater than the average foam diameter of the foam in the thickness direction is preferable from the viewpoint of having moderate cushioning properties.

The average foam diameter of the foam base material according to the present embodiment in the thickness direction may be in a range of 1 μm to 150 μm, in a range of 5 μm to 100 μm, or in a range of 10 μm to 60 μm. The average foam diameter of the foam base material in the flow direction and the width direction may be in a range of 1.2 to 700 μm, in a range of 10 to 500 μm, in a range of 50 to 300 μm, or in a range of 50 to 160 μm. In a case where the average foam diameter thereof is set to be in the above-described ranges, independent foams are likely to be formed even when the width of the double-sided tape is reduced, and the path through which water enters from the cross section of the foam base material can be suitably blocked.

In the foam base material of the present embodiment, the ratio between the average foam diameters is not particularly limited, but the ratio of the average foam diameter in the flow direction of the foam base material to the average foam diameter in the thickness direction of the foam base material (average foam diameter in flow direction/average foam diameter in thickness direction) may be in a range of 1.2 to 15 or in a range of 3 to 8. Further, the ratio of the average foam diameter in the width direction of the foam base material to the average foam diameter in the thickness direction of the foam base material (average foam diameter in width direction/average foam diameter in thickness direction) may be in a range of 1.2 to 15 or in a range of 3 to 8. Further, it is still preferable that the ratios in both the flow direction and the width direction are in the above-described ranges. When the ratio thereof is 1.2 or greater, the flexibility of the foam base material in the thickness direction is easily ensured, and thus the followability is improved. Further, when the ratio thereof is 15 times or less, variation in the flexibility and the tensile strength of the foam base material in the flow direction and the width direction is unlikely to occur.

Further, the ratio between the average foam diameters in the flow direction and the width direction may be in a range of 0.25 to 4 times or in a range of 0.33 to 3 times in a case where the ratio of the average foam diameter in the flow direction is set to 1. When the ratio thereof is in the above-described ranges, variation in the flexibility and the tensile strength in the flow direction and the width direction of the foam base material is unlikely to occur.

Further, the average foam diameters in the width direction, the flow direction, and the thickness direction of the foam base material are measured as follows.

First, the foam base material is cut to a size of 1 cm in the width direction and 1 cm in the flow direction.

Next, the magnification of a digital microscope (trade name “KH-7700”, manufactured by HiROX Co., Ltd.) is set to 200 times, and the cut surface of the foam base material in the width direction and the flow direction is observed. In this case, the entire length of the cut surface of the foam base material in the thickness direction is observed. In the observation, the foam diameters of all foams present within a range of 2 mm in the flow direction or the width direction of the cut surface are measured. Next, the range of 2 mm is changed, and the foam diameters of all foams present in optional ten ranges are measured.

The value obtained by calculating the average value of the measured foam diameters is defined as the average foam diameter.

The foam base material to be used may be, for example, a foam base material having a 25% compressive strength of 20 kPa or greater, a foam base material having a 25% compressive strength of 30 kPa to 1500 kPa, or a foam base material having a 25% compressive strength of 50 kPa to 1000 kPa from the viewpoint of exhibiting suitable adhesive strength to the adherend having an uneven shape or a rough surface.

Further, the 25% compressive strength is measured in conformity with JIS K 6767. The sample is cut into 25 square pieces, and the pieces are stacked until the thickness thereof reaches about 10 mm. The sample is sandwiched between stainless steel plates with an area greater than the area of the sample, and the strength when the sample is compressed by about 2.5 mm (25% of the original thickness) at 23° C. and a rate of 10 mm/min is measured.

The tensile strengths of the foam base material in the flow direction and the width direction are not particularly limited, but may be each 500 N/cm² or greater or in a range of 600 to 1800 N/cm². Further, the tensile strength that is lower than the other between the flow direction and the width direction may be in a range of 500 to 1400 N/cm² or in a range of 600 to 1200 N/cm². In this case, the tensile strength that is higher than the other between the directions may be in a range of 700 to 1800 N/cm² or in a range of 800 to 1600 N/cm². Further, the tensile elongation when the sample is cut in the tensile test is not particularly limited, but the tensile elongation in the flow direction may be in a range of 200% to 1500%, in a range of 400% to 1000%, in a range of 620% to 950%, or in a range of 450% to 800%. In a case where a foam base material whose tensile strength and the tensile elongation are in the above-described ranges is used, deterioration of the processability and degradation of attaching workability of the pressure-sensitive adhesive tape can be suppressed even when the base material is foamed and flexible. Further, the foam base material is unlikely to break or tear between layers when the pressure-sensitive adhesive tape is peeled off, and the pressure-sensitive adhesive tape can be easily peeled off even in a case where cracks occur between layers.

Further, the tensile strengths of the above-described foam base material in the flow direction and the width direction are measured in conformity with JIS K 6767. The maximum strength of a sample with a gauge length of 2 cm and a width of 1 cm is measured using a Tensilon tensile tester under measurement conditions of a tensile speed of 300 mm/min in an environment of 23° C. and 50% RH.

The apparent density of the foam base material is not particularly limited, but may be in a range of 0.08 to 0.8 g/cm³, in a range of 0.1 to 0.7 g/cm³, or in a range of 0.15 to 0.65 g/cm³ from the viewpoint of adjusting the interlayer strength, the compressive strength, the average foam diameter, and the like to be in the above-described ranges and achieving both the impact resistance and excellent adhesiveness to the adherend. Further, the apparent strength is measured in conformity with JIS K 6767. The foam base material cut into a 4 cm×5 cm rectangle is prepared to have an area of about 15 cm³, and the mass thereof is measured to determine the apparent density thereof.

The foam base material to be used may be a foam base material having a thickness of 1500 μm or less, a foam base material having a thickness of 1300 μm or less, or a foam base material having a thickness of 700 μm or less from the viewpoint of imparting excellent processability of the tape and excellent followability to the adherend. The lower limit of the thickness may be 50 μm.

Further, the foam base material may include other layers as necessary. Examples of the other layers include a laminate layer such as a polyester film or a polyolefin film, a light-shielding layer, a light-reflecting layer, and an electrically conductive layer and a thermally conductive layer, such as a metal layer for the purpose of imparting dimension stability, satisfactory tensile strength, rework suitability, and the like to the pressure-sensitive adhesive tape.

In the present specification, the compressive strength or the tensile strength of the foam base material can be appropriately adjusted by the material of the base material and the foam structure to be used. The kind of the foam base material of the present embodiment is not particularly limited, and examples of the foam base material that may be used include an olefin-based resin foam formed of polyethylene, polypropylene, an ethylene-propylene copolymer resin, an ethylene-vinyl acetate copolymer, or the like; a polyurethane-based foam; and a rubber-based foam formed of acrylic rubber, other elastomers, or the like. Among these, an olefin-based resin foam may be used from the viewpoint of easily preparing a thin foam base material with excellent followability to the unevenness of the surface of the adherend, excellent shock absorbing properties, and the like and ease of recycling with an olefin-based resin that has been frequently used as an adherend containing a thermoplastic resin.

The olefin-based resin is a resin having an olefin-based monomer unit and can be produced by polymerizing an olefin-based monomer.

Examples of the olefin-based monomer include ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-actene, 1-decene, 1-dodecene, 1-tetradecene, 1-hexadecene, 1-actadecene, 1-eicosene, and derivatives thereof. Among these, from the viewpoints of the productivity and the cost, ethylene or propylene may be used. Therefore, it is preferable that the base material contains an olefin-based resin. Further, it is preferable that the olefin-based resin contains a polyethylene resin or an ethylene-propylene copolymer resin. Further, the olefin-based resin may be used alone or in combination of two or more kinds thereof.

In a case where the foam base material contains an olefin-based resin, the content thereof may be 70% by mass or greater and 99% by mass or less, 80% by mass or greater and 98% by mass or less, or 90% by mass or greater and 98% by mass or less with respect to the total amount (100% by mass) of the foam base material.

Examples of such a foam base material include a crosslinked olefin-based resin foam obtained by supplying an olefin-based resin and a thermally decomposable foaming agent into an extruder, crosslinking the foamable olefin-based resin sheet, formed by extruding the mixture from the extruder into a sheet shape, with electron beams, and foaming, stretching, and thinning the sheet. A known resin of the related art can be used as the olefin-based resin, but a resin containing 40% by mass or greater of a polyethylene-based resin obtained by using a metallocene compound containing a tetravalent transition metal is preferable. Further, the olefin-based resin may be produced by foaming the foam, slicing the foam sheet in the thickness direction, stretching the sheet with a heal roll, and skinning the sheet.

The foam base material may be subjected to a surface treatment such as a corona treatment, a flame treatment, a plasma treatment, a hot air treatment, an ozone/ultraviolet treatment, application using an easy adhesion treatment agent, or the like in order to improve the adhesiveness to the pressure-sensitive adhesive layer or other layers. The surface treatment is performed to obtain satisfactory adhesiveness to the pressure-sensitive adhesive by setting a wetting index obtained using a wetting reagent to 36 mN/m or greater or 40 mN/m or greater.

### <Other Components>

Further, in the present embodiment, a foam base material containing other polymer components, resin reinforcing agents such as crosslinking agents, antiaging agents, ultraviolet absorbing agents, fillers, polymerization inhibitors, surface adjusters, antistatic agents, antifoaming agents, viscosity adjusters, light stabilizers, weather stabilizers, heat stabilizers, antioxidants, leveling agents, organic pigments, inorganic pigments, pigment dispersants, silica beads, organic beads, and cellulose nanofibers; inorganic fillers such as silicon oxide, aluminum oxide, titanium oxide, zirconia, and antimony trioxide; and the like can be used as necessary within a range where the properties thereof are not impaired. From the viewpoint of maintaining moderate followability and cushioning properties, the content of a polyolefin-based resin foam base material used in the pressure-sensitive adhesive tape of one or more embodiments of the present invention may be in a range of 0.1% by mass to 10% by mass or in a range of 1% by mass to 7% by mass.

### (Pressure-Sensitive Adhesive Layer)

The pressure-sensitive adhesive layer of the present embodiment can be formed by using a pressure-sensitive adhesive composition. Such a pressure-sensitive adhesive composition constituting the pressure-sensitive adhesive layer is not particularly limited, but a pressure-sensitive adhesive composition having satisfactory adhesiveness to the base material can be used. For example, the pressure-sensitive adhesive composition of the present embodiment can be a pressure-sensitive adhesive composition containing one or two or more selected from the group consisting of an acrylic pressure-sensitive adhesive, a urethane-based pressure-sensitive adhesive, a rubber-based pressure-sensitive adhesive, and a silicone-based pressure-sensitive adhesive. Further, in the present embodiment, a pressure-sensitive adhesive composition containing a water-dispersible emulsion type pressure-sensitive adhesive can also be used.

From the viewpoint of easily obtaining relatively strong pressure-sensitive adhesive strength, an acrylic pressure-sensitive adhesive composition is preferable as the pressure-sensitive adhesive composition of the present embodiment. As the acrylic pressure-sensitive adhesive composition, a composition obtained by using one or two or more kinds of (meth)acrylic polymers selected from the group consisting of (meth)acrylate homopolymers and copolymers of (meth)acrylate and other monomers as base polymers (components of the acrylic pressure-sensitive adhesive) and blending an additive such as a tackifying resin or a crosslinking agent with the polymers can be preferably used.

### <Acrylic Pressure-Sensitive Adhesive Composition>

It is preferable that the pressure-sensitive adhesive layer of the present embodiment be formed by using the acrylic pressure-sensitive adhesive composition.

The (meth)acrylic polymer serving as the base polymer (component of the acrylic pressure-sensitive adhesive) of the acrylic pressure-sensitive adhesive composition is not particularly limited, but contains, for example, at least one polymer having a (meth)acrylic acid alkyl ester monomer as a monomer unit. The (meth)acrylic acid alkyl ester monomer is, for example, (meth)acrylic acid alkyl ester in which the number of carbon atoms of the alkyl group is in a range of 2 to 14 and is not particularly limited. For example, alkyl (meth)acrylate such as methyl (meth)acrylate, ethyl (meth)acrylate, n-butyl (meth)acrylate, s-butyl (meth)acrylate, t-butyl (meth)acrylate, isobutyl (meth)acrylate, hexyl (meth)acrylate, 2-ethylhexyl (meth)acrylate, n-actyl (meth)acrylate, isooctyl (meth)acrylate, n-nonyl (meth)acrylate, isononyl (meth)acrylate, n-decyl (meth)acrylate, isodecyl (meth)acrylate, n-undecyl (meth)acrylate, n-dodecyl (meth)acrylate, n-tridecyl (meth)acrylate, or n-tetradecyl (meth)acrylate can be used as the (meth)acrylic acid alkyl ester monomer. One or two or more kinds thereof can be used. Among these, from the viewpoint that the adhesiveness to the adherend is likely to be ensured and the cohesive power is excellent, it is preferable to use (meth)acrylic acid alkyl ester in which the number of carbon atoms of the alkyl group is in a range of 1 to 8, particularly, n-butyl acrylate or 2-ethylhexyl acrylate.

Further, in the present specification, “(meth)acrylic acid alkyl ester” denotes acrylic acid alkyl ester or methacrylic acid alkyl ester.

The content of the (meth)acrylic acid alkyl ester monomer unit in the (meth)acrylic polymer may be in a range of 50% to 98.5% by mass or in a range of 80% to 98.5% by mass with respect to the amount of all monomer units constituting the (meth)acrylic polymer.

It is preferable that a monomer containing a polar group such as a hydroxyl group, a carboxyl group, or an amino group in a side chain, for example, an acrylic acid ester monomer or any of other vinyl-based monomers be copolymerized with the (meth)acrylic polymer.

In this manner, these monomer-derived constitutional units (monomer units) serve as crosslinking points in the (meth)acrylic polymer so that the hardness of the pressure-sensitive adhesive component can be adjusted to exhibit target pressure-sensitive adhesive strength.

The vinyl monomer containing a hydroxyl group is preferable as the monomer containing a hydroxyl group, and hydroxyl group-containing (meth)acrylate such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, or 12-hydroxylauryl (meth)acrylate can be used.

The content of the monomer containing a hydroxyl group may be in a range of 0.01% by mass to 0.2% by mass, in a range of 0.01% by mass or greater and less than 0.1% by mass, or in a range of 0.02% by mass to 0.08% by mass from the viewpoint of setting the tensile strength of the pressure-sensitive adhesive layer to be in a specific range and obtaining more excellent adhesive strength and retention power.

The vinyl monomer containing a carboxyl group is preferable as the monomer containing a carboxyl group, and examples thereof include acrylic acid, methacrylic acid, itaconic acid, maleic acid, a (meth)acrylic acid dimer, and crotonic acid. Among these, acrylic acid may be used as a copolymer component. The content of the monomer containing a carboxyl group is not particularly limited as long as the content thereof is the amount set such that the acid value of the (meth)acrylic polymer is in a predetermined preferable range, but may be in a range of 1% by mass to 30% by mass, in a range of 1% by mass to 15% by mass, or in a range of 1% by mass to 7% by mass with respect to the total amount of the monomer component from the viewpoint of obtaining more excellent adhesive strength and retention power.

Further, examples of the monomer containing an amide group include N-vinylpyrrolidone, N-vinylcaprolactam, acryloylmorpholine, acrylamide, and N,N-dimethylacrylamide.

Examples of other highly polar vinyl monomers include vinyl acetate, ethylene oxide-modified succinic acid acrylate, and a sulfonic acid group-containing monomer such as 2-acrylamido-2-methylpropanesulfonic acid.

Further, in a case where an isocyanate-based crosslinking agent is blended with the acrylic pressure-sensitive adhesive composition, a (meth)acrylic polymer obtained by copolymerizing the highly polar vinyl monomer that contains a functional group reacting with an isocyanate group may be used. As the highly polar vinyl monomer that contains a functional group reacting with an isocyanate group, a hydroxyl group-containing vinyl monomer is preferable, and 2-hydroxyethyl (meth)acrylate, 4-hydroxybutyl (meth)acrylate, or 6-hydroxyhexyl (meth)acrylate is particularly preferable. The content of the hydroxyl group-containing vinyl monomer unit reacting with an isocyanate-based crosslinking agent may be in a range of 0.01% to 1.0% by mass or 0.03% to 0.3% by mass with respect to the amount of all monomer units constituting the (meth)acrylic polymer.

The (meth)acrylic polymer of the present embodiment can be obtained by copolymerization using a solvent polymerization method, a bulk polymerization method, a suspension polymerization method, an emulsion polymerization method, an ultraviolet irradiation method, or an electron beam irradiation method. However, from the viewpoint of water resistance of the pressure-sensitive adhesive composition, particularly, water resistance of the base polymer, a solution polymerization method or a bulk polymerization method is preferable. A method of initiating the polymerization can also be optionally selected from a method of initiating polymerization by heat using a peroxide-based thermal polymerization initiator such as benzoyl peroxide or lauroyl peroxide, or an azo-based thermal polymerization initiator such as azobisisobutyronitrile, a method of initiating polymerization by irradiation with ultraviolet rays using a photopolymerization initiator such as an acetophenone-based initiator, a benzoin ether-based initiator, a benzyl ketal-based initiator, an acylphosphine oxide-based initiator, a benzoin-based initiator, or a benzophenone-based initiator, and a method of initiating polymerization by irradiation with electron beams.

From the viewpoints of coating properties and pressure-sensitive adhesive physical properties, the weight-average molecular weight of the (meth)acrylic polymer according to the present embodiment may be in a range of 400000 to 1600000 or in a range of 600000 to 1200000. The weight-average molecular weight is measured in terms of standard polystyrene by permeation chromatography (GPC). The conditions for measuring the weight-average molecular are as described in the section of examples below.

A pressure-sensitive adhesive layer having a gel fraction of 25% by mass to 70% by mass may be used and a pressure-sensitive adhesive layer having a gel fraction of 30% by mass to 60% by mass may be used as the pressure-sensitive adhesive layer formed by using the (meth)acrylic pressure-sensitive adhesive composition. In a case where the gel fraction is in the above-described ranges, both the cohesiveness and the adhesiveness are satisfactory. Further, a method of calculating the gel fraction is as described in the section of the examples below.

### <Rubber-Based Pressure-Sensitive Adhesive Composition>

The pressure-sensitive adhesive layer of the present embodiment may be formed by using a rubber-based pressure-sensitive adhesive composition. The rubber-based pressure-sensitive adhesive composition contains one or two or more rubber-based pressure-sensitive adhesives selected from a natural rubber-based polymer such as natural rubber or a modified material thereof, a synthetic rubber polymer such as butyl rubber or isoprene rubber, and a block copolymer rubber-based polymer such as a vinyl aromatic block copolymer or an acrylic block copolymer and may be blended with an additive such as a tackifying resin or a crosslinking agent as necessary. Among these, a rubber-based pressure-sensitive adhesive composition containing a block copolymer rubber-based polymer has thermoplasticity, and thus can be melted and kneaded with a resin constituting the adherend during material recycling, which is preferable.

Examples of the vinyl aromatic block copolymer include a block copolymer of a polymer block formed of an aromatic vinyl compound (for example, styrene or α-methylstyrene) and a polymer block formed of a conjugated diene compound (for example, isoprene, butadiene, ethylene butylene, ethylene propylene, or farnesene). Among these, a diblock copolymer such as a styrene-isoprene copolymer, a styrene-butadiene copolymer, a styrene-ethylene butylene copolymer, or a styrene-ethylene propylene copolymer, and a triblock copolymer such as a styrene-isoprene-styrene copolymer, a styrene-butadiene-styrene copolymer, or a styrene-farnesene-styrene copolymer are preferable.

Examples of the acrylic block copolymer include a block copolymer of a polymer block formed of a methacrylic acid ester compound (for example, methyl methacrylate (MMVA) or ethyl methacrylate (EMA)) and a polymer block formed of an acrylic ester compound (for example, (meth)acrylic acid alkyl ester in which the number of carbon atoms in the alkyl group is in a range of 2 to 14, such as n-butyl acrylate (nBA) or 2-ethylhexyl acrylate (2EHA)). Among these, a triblock copolymer such as an MMA-nBA-MMA copolymer, an MMA-2EHA-MMA copolymer, or an MMA-nBA/2EHA-MMA copolymer is preferable.

Further, a polymer having a weight-average molecular weight of 10000 to 800000, measured in terms of standard polystyrene using gel permeation chromatography (GPC), may be used, and a polymer having a weight-average molecular weight of 30000 to 500000 may be used as the block copolymer rubber-based polymer.

A pressure-sensitive adhesive layer having a gel fraction of 0% by mass to 60% by mass may be used, and a pressure-sensitive adhesive layer having a gel fraction of 0% by mass to 40% by mass may be used as the pressure-sensitive adhesive layer formed of the rubber-based pressure-sensitive adhesive composition. The rubber-based pressure-sensitive adhesive composition formed of the block copolymer rubber-based polymer is preferable from the viewpoint that the gel fraction can be desired to 0%. Further, a method of calculating the gel fraction is as described in the section of the examples below.

### <Silicone-Based Pressure-Sensitive Adhesive Composition>

The pressure-sensitive adhesive layer of the present embodiment may be formed by using a silicone-based pressure-sensitive adhesive composition.

The silicone-based pressure-sensitive adhesive composition contains polyorganosilicones with different average molecular weights, which are usually referred to as a gum component and a resin component, as the base polymer (component of the silicone-based pressure-sensitive adhesive) and can be blended with an additive such as a metal catalyst or a crosslinking agent as necessary.

As the gum component, a component mainly serving as a binder component of aa pressure-sensitive adhesive can be used, and examples thereof include polyorganosilicone. As the polyorganosilicone, peroxide-curable polyorganosilicone and addition-curable polyorganosilicone are known, and both can be used. Examples of the addition-curable polyorganosilicone include polyorganosiloxane having a structure in which a polymerizable unsaturated double bond is bonded to a silicon atom. Further, the weight-average molecular weight of the polyorganosilicone used as the gum component, which is measured in terms of standard polystyrene using gel permeation chromatography (GPC), may be 150000 or greater or in a range of 150000 to 1000000.

The resin component can be used by being appropriately selected from those known in the related art, and polyorganosilicone having a relatively low molecular weight may be used, and addition-curable polyorganosilicone may be used. Further, the weight-average molecular weight of the polyorganosilicone used as the resin component, which is measured in terms of standard polystyrene using gel permeation chromatography (GPC), may be in a range of 100 to 10000 or in a range of 300 to 8000.

Further, as the metal catalyst that may be contained in the silicone-based pressure-sensitive adhesive composition, for example, an organometallic catalyst of Group 10 of the periodic table may be used, and specifically, a platinum-based catalyst may be used from the viewpoint of an excellent reaction acceleration effect.

The pressure-sensitive adhesive layer formed of the silicone-based pressure-sensitive adhesive composition may have a gel fraction of 70% by mass to 99% by mass or 75% by mass to 97% by mass. Further, a method of calculating the gel fraction is as described in the section of the examples below.

### <Crosslinking Agent>

It is preferable that the pressure-sensitive adhesive composition or the pressure-sensitive adhesive layer of the present embodiment contain a crosslinking agent in order to increase the cohesive power of the pressure-sensitive adhesive layer. Examples of such a crosslinking agent include an isocyanate-based crosslinking agent, an epoxy-based crosslinking agent, a metal chelate-based crosslinking agent, and an aziridine crosslinking agent. Among these, a crosslinking agent of a type that is added after completion of polymerization and promotes the crosslinking reaction is preferable, an isocyanate-based crosslinking agent and an epoxy-based crosslinking agent that are highly reactive to a (meth)acrylic polymer are more preferable, and an isocyanate-based crosslinking agent is particularly preferable from the viewpoint that the adhesive strength, the retention power, and adhesiveness between the base material and the pressure-sensitive adhesive layer are imparted, an urethane bond bonded between the isocyanate-based crosslinking agent and the hydroxyl group of the pressure-sensitive adhesive resin in the material recycling step is moderately cleaved by thermal decomposition, and the isocyanate-based crosslinking agent is moderately compatible with the adherend or the resin of the base material.

Examples of the isocyanate-based crosslinking agent include tolylene diisocyanate, naphthylene-1,5-diisocyanate, hexamethylene diisocyanate, diphenylmethane diisocyanate, xylylene diisocyanate, and trimethylolpropane-modified tolylene diisocyanate. A trifunctional polyisocyanate-based compound is particularly preferable. Examples of the trifunctional isocyanate-based compound include tolylene diisocyanate, a trimethylolpropane adduct thereof, and a triphenylmethane isocyanate.

Further, a gel fraction value obtained by measuring insoluble matter after immersing the pressure-sensitive adhesive layer in toluene for 24 hours is used as an index of the degree of crosslinking.

### <Tackifying Resin>

It is preferable that the pressure-sensitive adhesive composition or the pressure-sensitive adhesive layer of the present embodiment contains a tackifying resin in order to improve the pressure-sensitive adhesive strength of the pressure-sensitive adhesive layer. Examples of the tackifying rein include a rosin-based resin, a polymerized rosin-based resin, a polymerized rosin ester-based resin, a rosin phenol-based resin, a stabilized rosin ester-based resin, a disproportionated rosin ester-based resin, a hydrogenated rosin ester-based resin, a terpene-based resin, a terpene phenol-based resin, a petroleum-based resin, and a (meth)acrylate-based resin. In a case where an emulsion type pressure-sensitive adhesive composition is used, it is preferable to use an emulsion type tackifying resin.

Among these, a disproportionated rosin ester-based resin, a polymerized rosin ester-based resin, a rosin phenol-based resin, a hydrogenated rosin ester-based resin, and a (meth)acrylate-based resin are preferable as the tackifying resin.

The softening point of the tackifying resin is not particularly limited, but may be in a range of 30° C. to 180° C. or in a range of 70° C. to 160° C. Further, one or two or more kinds of tackifying resins may be used. High adhesion performance can be expected by blending a tackifying resin having a high softening point. The softening point denotes a value measured by

The method (ring and ball type) specified in JIS K 6220-1.

In the blending ratio in a case of using the (meth)acrylic polymer and the tackifying resin, the content of the tackifying resin may be in a range of 5 to 80 parts by mass, in a range of 7 to 70 parts by mass, or in a range of 10 to 60 parts by mass with respect to 100 parts by mass of the (meth)acrylic polymer. When the ratio between the (meth)acrylic polymer and the tackifying resin is set to be in the above-described ranges, the adhesiveness to the adherend is likely to be ensured. Further, in a case where the rubber-based pressure-sensitive adhesive composition is used as the pressure-sensitive adhesive, it is preferable that 50 to 150 parts by mass of the tackifying resin is added to the composition with respect to 100 parts by mass of the rubber-based pressure-sensitive adhesive. Further, the tackifying resin is not usually added to the composition in a case where a silicone-based pressure-sensitive adhesive is used as the pressure-sensitive adhesive.

### <Other Components>

Further, the pressure-sensitive adhesive composition or the pressure-sensitive adhesive layer of the present embodiment may contain other known additives that have been commonly used, as necessary. Specifically, the pressure-sensitive adhesive can contain, as the additives, other polymer components, additives such as ultraviolet absorbing agents, fillers, polymerization inhibitors, surface adjusters, antistatic agents, antifoaming agents, viscosity adjusters, light stabilizers, weather stabilizers, heat stabilizers, antioxidants, leveling agents, organic pigments, inorganic pigments, pigment dispersants, plasticizers, softening agents, flame retardants, metal deactivators, resin reinforcing agents, and organic beads; and inorganic fillers such as silicon oxide, aluminum oxide, titanium oxide, zirconia, and antimony pentoxide, within a range where the properties thereof are not impaired.

The content of the additive may be 0% by mass or greater and 10% by mass or less or 0% by mass or greater and 5% by mass or less with respect to the total amount of the pressure-sensitive adhesive composition or the pressure-sensitive adhesive layer of the present embodiment.

Among the examples, it is preferable that the pressure-sensitive adhesive composition or the pressure-sensitive adhesive layer of the present embodiment contain one or two or more selected from an antioxidant, an ultraviolet absorbing agent, a heat stabilizer, and a resin reinforcing agent.

In this manner, an effect of suppressing deterioration of the strength of the resin recycled in a high-temperature environment during melt-kneading and extrusion molding is exhibited.

Specific examples of the antioxidant include 2,6-di-t-butyl-4-methylphenol, tetrakis-[methylene-3-(3′,5′-di-t-butyl-4′-hydroxyphenyl)propionate]methane, n-actadecyl-3-(4′-hydroxy-3′,5′-di-t-butylphenyl)propionate, pentaerythritol-tetrakis[3-(3,5-di-t-butyl-4-hydroxyphenyl)propionate], and 3,9-bis[2-{3-(3-t-butyl-4-hydroxy-5-methylphenyl)propionyloxy}-1,1-dimethylethyl]-2,4,8,10-tetraoxaspiro[5,5]undecane.

Examples of the ultraviolet absorbing agent include a benzotriazole-based ultraviolet absorbing agent, a benzophenone-based ultraviolet absorbing agent, a salicylic acid-based ultraviolet absorbing agent, a cyanoacrylate-based ultraviolet absorbing agent, a hindered phenol-based ultraviolet absorbing agent, and a triazine-based ultraviolet absorbing agent.

Examples of the heat stabilizer include a hindered phenol-based compound, a phosphorus compound, a lactone-based compound, a hydroxylamine-based compound, and a sulfur-based compound.

Examples of the resin reinforcing agent include known materials. Among these, a fibrous or particulate material is preferable, and a material having a size (100 μm or less) suitable for extrusion molding is preferable.

### <Properties of Pressure-Sensitive Adhesive Layer>

The thickness of the pressure-sensitive adhesive layer is not particularly limited, but may be in a range of 5 to 100 μm, in a range of 5 to 75 μm, or in a range of 10 to 60 μm. When the thickness thereof is in the above-described ranges, both the adhesiveness and thinning of the tape are likely to be achieved.

### (Method of Producing Pressure-Sensitive Adhesive Tape)

A method of producing the pressure-sensitive adhesive tape of the present embodiment is not particularly limited, and the pressure-sensitive adhesive tape can be produced by a known method. Specifically, the pressure-sensitive adhesive tape can be obtained by initially producing a laminated film and cutting the laminated film into a desired shape. A method of producing the laminated film may include, for example, the following procedures (i) and (ii).

(i) A surface of a release liner is coated with the pressure-sensitive adhesive composition and dried to form a pressure-sensitive adhesive layer on one surface of the release liner (that is, two sheets of release liners on which the pressure-sensitive adhesive layers are formed are prepared). In this case, when the pressure-sensitive adhesive layer is formed on at least one surface of the release liner, and a portion that is not coated with the pressure-sensitive adhesive composition may be formed on the release liner using a gravure printing method, a die coating method, or a comma coating method to form an adhesive-free portion in the pressure-sensitive adhesive layer.

(ii) Next, the pressure-sensitive adhesive layer in a state of having the release liner is attached to a surface of a prepared base material, and pressurized or the like as necessary.

Further, the laminated film or the pressure-sensitive adhesive film may be formed such that a release liner is laminated for protecting the pressure-sensitive adhesive layer as necessary. The release liner is not particularly limited, and at least one surface or both surfaces of a base material, for example, a synthetic resin film such as polyethylene, polypropylene, or a polyester film, paper, nonwoven fabrics, cloth, a foam sheet, metal foil, or a laminate thereof can be subjected to a release treatment such as a silicone treatment for increasing peeling properties from the pressure-sensitive adhesive, a long-chain alkyl treatment, or a fluorine treatment and then used.

Another aspect of the present disclosure relates to a component containing a thermoplastic resin, to which the recyclable pressure-sensitive adhesive tape of the present embodiment is attached. The component is not particularly limited, and examples thereof include electric/electronic equipment and components thereof, OA equipment and components thereof, information terminal equipment and components thereof, machine components, household electric appliances, moving object components (aircraft components and railway vehicle components), vehicle components (automobile interiors and exteriors), building members, various containers, leisure goods/miscellaneous goods, and lighting equipment.

In a case where the thermoplastic resin contained in the component and the pressure-sensitive adhesive tape satisfy Relational Formula (1), an effect that the pressure-sensitive adhesive tape can be recycled in a state of being attached to the component containing a thermoplastic resin and the rate of a decrease in tensile strength of the reproduced plastic material after being recycled is small is exhibited.

Still another aspect of the present embodiment relates to electronic equipment or a moving object, which is formed by using the component containing a thermoplastic resin, to which the recyclable pressure-sensitive adhesive tape of the present embodiment is attached.

The moving object is not particularly limited, and examples thereof include moving objects such as vehicles, aircrafts, ships, bulldozers, excavators, truck cranes, and forklifts. Further, examples of the vehicles include four-wheeled automobiles (passenger cars, trucks, buses, and the like) such as automobiles using gasoline or bioethanol as fuel, electric automobiles using secondary batteries or fuel cells, and hybrid automobiles; two-wheeled motorcycles, bicycles; and railway vehicles (trains, hybrid trains, locomotives, Shinkansen, linear motor cars, and the like).

### EXAMPLES

Hereinafter, one or more embodiments of the present invention will be described in more detail with reference to examples, but the present invention is not limited to the following examples.

### 1. MEASUREMENT AND EVALUATION METHOD

The pressure-sensitive adhesive tape obtained in each example and each comparative example was measured and evaluated by the following method.

### (1) Gel Fraction (Mass %)

A surface of a release liner, on which a release treatment had been performed, was attached to each pressure-sensitive adhesive layer in the pressure-sensitive adhesive tape prepared in each example, and the layer was aged in an environment of 40° C. for 2 days to form a pressure-sensitive adhesive layer for measuring a gel fraction. The obtained pressure-sensitive adhesive layer was cut into a square having a length of 50 mm and a width of 40 mm to obtain a test piece. A mass (G1) of the test piece was measured, the test piece was immersed in 50 g of toluene for 24 hours in an environment of 23° C., a mixture of the test piece after the immersion and toluene was filtered through a 300 mesh wire netting to extract a component insoluble in toluene, and a mass (G2) of the insoluble component after being dried in an environment of 105° C. for 1 hour was measured. The gel fraction thereof was calculated based on the following equation of the mass (G1) and the mass (G2).

$$Gel fraction ( mass \% ) = ( G 2 / G 1 ) \times 100$$

(2) The average thickness of the base material, the average thickness (coating thickness) of the pressure-sensitive adhesive layer, and the average thickness of the pressure-sensitive adhesive tape were measured with Dial Thickness Gauge G type (manufactured by OZAKI MFG. CO., LTD.) (n=3).

(3) 25% Compressive Strength (kPa)

The 25% compressive strength of the base material was measured in conformity with JIS K 6767. Specifically, the base material used in each example was cut into a size of 25 mm square and used as a sample, the sample was placed on a stainless steel plate having an area greater than that of the sample, and the strength when the sample was compressed by 25% of the initial thickness at a rate of 0.5 mm/min using a stainless steel probe with a diameter of 7 mm under conditions of 23° C. and 50% RH was measured.

### (4) Content of Polyolefin in Pressure-Sensitive Adhesive Tape (=Content of Olefin-Based Resin in Pressure-Sensitive Adhesive Tape)

$$mass ( g ) of pressure - sensitive adhesive layer \times content ( mass \% ) of olefin - based resin of pressure - sensitive adhesive layer / 100 \qquad X$$

$$mass ( g ) of base material \times content ( mass \% ) of olefin - based resin of base material / 100 \qquad Y$$

$$Content ( \% ) of olefin = ( X + Y ) / mass ( g ) of pressure - sensitive adhesive tape \times 100$$

### (5) Content (Mass %) of Pressure-Sensitive Adhesive Tape

The content of the pressure-sensitive adhesive tape (the content of the pressure-sensitive adhesive tape in the entire molded article or the entire reproduced plastic material) is calculated from the blending ratio of the pressure-sensitive adhesive tape to the entire molded article or the entire reproduced plastic material.

### (6) Tensile Strength (MPa) and Tensile Strain at Strength (%)

A tensile test was performed on molded articles (1) to (4) of a multipurpose test piece type A1 prepared as described below using a tensile tester (manufactured by Shimadzu Corporation) under measurement conditions of a distance of 115 mm between gripping jigs, a reference line spacing of 75 mm, a test speed of 50 mm/min, a temperature of 23° C., and a humidity of 50% RH in conformity with JIS K 7161-1, and the tensile strength (MPa) and the tensile strain at strength (%) thereof were measured.

### (7) Flexural Strength (MPa) and Flexural Strain at Flexural Strength (%)

A three-point flexural test was performed on the molded articles (1) to (4) of the multipurpose test piece type A1 prepared as described below using a tensile tester (manufactured by Shimadzu Corporation) under measurement conditions of a test speed of 2 mm/min, a distance of 64 mm between lower fulcrum, a temperature of 23° C., and a humidity of 50% RH in conformity with JIS K 7171, and the flexural strength (maximum flexural stress, MPa) and the flexural strain at flexural strength (%) were measured.

### (8) Confirmation of Dispersion State of Pressure-Sensitive Adhesive Components in Mixture

A PET film (UNITIKA 5-100) having a thickness of 100 μm was laid over the entire surface of an iron plate of a heat press machine (manufactured by TESTER SANGYO CO., LTD., TP-750 model), and about 2 g of pellets of reproduced plastic materials (1) to (4) obtained as described below were spread out in a central portion of the PET film such that the pellets did not overlap each other. Next, the same PET film was placed on the pellets and pressed to have a diameter of about 14 cm at 180° C. to prepare a sheet. The sheet was cut into a size of 10 cm square to visually confirm the presence or absence of foreign matter (dispersion failure of the pressure-sensitive adhesive tape).

### (9) Weight-Average Molecular Weight (GPC) of Pressure-Sensitive Adhesive Resin

The weight-average molecular weight defined in the present specification denotes a value measured by a gel permeation chromatography method (GPC method) and calculated in terms of standard polystyrene. Specifically, the weight-average molecular weight can be measured using a GPC device (HLC-8320GPC) under the following conditions.
Sample concentration: 0.5% by mass (tetrahydrofuran solution)
Sample injection volume: 100 μl
Eluent: tetrahydrofuran
Flow rate: 0.8 ml/min
Measurement temperature: 40° C.
Main column: two columns of TSKgel GMHHR-H (20)
Guard column: TSKgel HXL-H
Detector: differential refractometer
Weight-average molecular weight in terms of polystyrene: 10000 to 20000000 (manufactured by Tosoh Corporation)

The weight-average molecular weight of the pressure-sensitive adhesive resin contained in the second coating solution described below is a value measured and calculated by the above-described method.

### 2. EXAMPLES

### (2-1) Preparation of Pressure-Sensitive Adhesive Composition

### Preparation Example 1: Pressure-Sensitive Adhesive Composition (P-1)

A reaction container provided with a stirrer, a reflux condenser, a nitrogen introduction pipe, and a thermometer was charged with 79.9 parts by mass of n-butyl acrylate, 6 parts by mass of 2-ethylhexyl acrylate, 10 parts by mass of cyclohexyl acrylate, 4 parts by mass of acrylic acid, 0.1 parts by mass of 4-hydroxybutyl acrylate, and 150 parts by mass of ethyl acetate as the composition of the monomer used, and the mixture was heated to 72° C. while being stirred and nitrogen was blown into the mixture. Next, 2 parts by mass (solid content of 0.1% by mass) of a 2,2′-azobis(2-methylbutyronitrile) solution which had been dissolved in ethyl acetate in advance was added to the mixture, the solution was held at 72° C. for 4 hours and further held at 75° C. for 5 hours while being stirred. The mixture was diluted with ethyl acetate and filtered through a 200 mesh wire netting, thereby obtaining a solution (solid content concentration of 26%) of an acrylic polymer (A-1) with a weight-average molecular weight of 1060000.

5 parts by mass of a polymerized rosin ester-based tackifying resin (D-125) (manufactured by ARAKAWA CHEMICAL INDUSTRIES, LTD.) and 15 parts by mass of an aromatic hydrocarbon resin FTR6125 (manufactured by Mitsui Chemicals, Inc.) were mixed and stirred with 100 parts by mass of the acrylic polymer (A-1), and ethyl acetate was added thereto, thereby obtaining a pressure-sensitive adhesive solution with a solid content of 30% by mass. Next, 1.0 parts by mass of BURNOCK D-40A (manufactured by DIC Corporation, adduct of tolylene diisocyanate and trimethylolpropane, non-volatile content of 40% by mass, hereinafter, referred to as D-40A) was added as a crosslinking agent to 100 parts by mass of the pressure-sensitive adhesive solution, and the solution was uniformly stirred and mixed, thereby obtaining a pressure-sensitive adhesive composition (P-1). The content of the polyolefin-based resin in the pressure-sensitive adhesive composition (P-1) (containing no solvent) was 0% by mass.

### Preparation Example 2: Pressure-Sensitive Adhesive Composition (P-2)

A solution (non-volatile content of 35% by mass) of an acrylic polymer (A-2) with a weight-average molecular weight of 1000000 was obtained by the same method as in Preparation Example 1 except that a reaction container was charged with 93.4 parts by mass of n-butyl acrylate, 3.0 parts by mass of vinyl acetate, 3.5 parts by mass of acrylic acid, and 0.1 parts by mass of 2-hydroxyethyl acrylate.

9.3 parts by mass of a polymerized rosin ester-based tackifying resin (D-125) (manufactured by ARAKAWA CHEMICAL INDUSTRIES, LTD.) and 9.3 parts by mass of a disproportionated rosin ester-based tackifying resin A-100 (manufactured by ARAKAWA CHEMICAL INDUSTRIES, LTD.) were mixed and stirred with 100 parts by mass of the acrylic polymer (A-2), and ethyl acetate was added thereto, thereby obtaining a pressure-sensitive adhesive solution with a solid content of 38% by mass. Next, 1.2 parts by mass of BURNOCK D-40A was added as a crosslinking agent to 100 parts by mass of the pressure-sensitive adhesive solution, and the solution was uniformly stirred and mixed, thereby obtaining a pressure-sensitive adhesive composition (P-2). The content of the polyolefin-based resin in the pressure-sensitive adhesive composition (P-2) (containing no solvent) was 0% by mass.

### (2-2) Preparation of Pressure-Sensitive Adhesive Tape

### Example 1: Preparation of Pressure-Sensitive Adhesive Tape (1)

A surface of a release liner, which had been subjected to a release treatment, was coated with the pressure-sensitive adhesive composition (P-1) using a bar coater such that the thickness of the dried pressure-sensitive adhesive layer reached 50 μm, and was dried at 80° C. for 3 minutes, thereby preparing a pressure-sensitive adhesive layer.

Next, the pressure-sensitive adhesive layer was attached to both surfaces of a polypropylene-based foam base material (apparent density: 0.2 g/cm³, polyolefin content of foam base material: 93.4% by mass, wetting index was adjusted to 54 mN/m by performing corona treatment on surface) with a thickness of 300 μm, and the base material was protected in an environment of 40° C. for 48 hours, thereby preparing a pressure-sensitive adhesive tape (1).

The properties of the obtained pressure-sensitive adhesive tape (1) are listed in Table 1.

### Example 2: Preparation of Pressure-Sensitive Adhesive Tape (2)

A surface of a release liner was coated with the pressure-sensitive adhesive composition (P-2) using a bar coater such that the thickness of the dried pressure-sensitive adhesive layer reached 75 μm, and dried at 80° C. for 3 minutes, thereby preparing a pressure-sensitive adhesive layer.

Next, the pressure-sensitive adhesive layer was attached to both surfaces of a polyethylene-based foam base material (apparent density: 0.2 g/cm³, polyolefin content of foam base material: 94.9% by mass, wetting index was adjusted to 54 mN/m by performing corona treatment on surface) with an average thickness of 200 μm, and the base material was protected in an environment of 40° C. for 48 hours, thereby preparing a pressure-sensitive adhesive tape (2).

The properties of the obtained pressure-sensitive adhesive tape (2) are listed in Table 1.

TABLE 1

| | | Example 1 | Example 2 |
|---|---|---|---|
| Type of pressure-sensitive | | Pressure-sensitive | Pressure-sensitive |
| adhesive tape | | adhesive tape (1) | adhesive tape (2) |
| Pressure- | Type of pressure- | P-1 | P-2 |
| sensitive | sensitive adhesive | | |
| adhesive | composition | | |
| layer | Solid content of | 30 | 38 |
| | pressure-sensitive | | |
| | adhesive composition | | |
| | (mass %) | | |
| | Crosslinking agent | 1 | 1 |
| | (parts by mass) | | |
| | Content of polyolefin | 0 | 0 |
| | [%] | | |
| | Gel fraction [%] | 53 | 46 |
| | Coating thickness [μm] | 50 | 75 |
| | Coating amount [g/m²] | 55 | 80 |
| Base | Type | Polypropylene- | Polyethylene- |
| material | | based | based |
| | Density [g/cm³] | 0.20 | 0.2 |
| | Thickness [μm] | 300 | 200 |
| | Mass [g/m²] | 62 | 40 |
| | 25% compressive | 90 | 50 |
| | strength [kPa] | | |
| | Foaming ratio [times] | 5 | 5 |
| | Content of polyolefin | 93.4 | 94.9 |
| | [%] | | |
| Pressure- | Thickness [μm] | 400 | 350 |
| sensitive | Mass [g/m²] | 172 | 200 |
| adhesive | Content of polyolefin | 33.7 | 19.0 |
| tape | [%] | | |

### 3. PREPARATION OF REPRODUCED PLASTIC MATERIAL AND MOLDED ARTICLE

### (3-1) Preparation of Reproduced Plastic Material (1) and Molded Article (1) Using Pressure-Sensitive Adhesive Tape (1)

The pressure-sensitive adhesive tape (1) (from which the release liner was peeled off) was mixed with a polypropylene resin (J106G, manufactured by Prime Polymer Co., Ltd., melting point of 160° C., pellet) such that the proportion of the pressure-sensitive adhesive tape (1) was 1% by mass with respect to the polypropylene resin, and the mixture was melted and kneaded under conditions of 180° C., a kneading speed of 350 rpm, a screw rotation speed of 300 rpm, and a discharge speed of 5 kg/h using a twin-screw extruder (KZW25, manufactured by TECHNOVEL CORPORATION) heated to 180° C., thereby obtaining a pellet body of the reproduced plastic material (1) containing 1% by mass of the pressure-sensitive adhesive tape (1).

A molded article (1) of a multipurpose test piece type A1 obtained in conformity with JIS K 7139 was prepared by using the pellet body of the reproduced plastic material (1) obtained above in an injection molding machine (PNX60III, manufactured by NISSEI PLASTIC INDUSTRIAL CO., LTD., molding machine temperature: 180° C., mold temperature: 40° C.).

### (3-2) Preparation of Reproduced Plastic Material (2) and Molded Article (2) Using Pressure-Sensitive Adhesive Tape (1)

A pellet of the reproduced plastic material (2) and a molded article (2) of a multipurpose test piece type A1 obtained in conformity with JIS K 7139 were prepared by the same operation as in the preparation of the molded article (1) described in the section (3-1) except that the pressure-sensitive adhesive tape (1) (from which the release liner was peeled off) obtained above was mixed with the polypropylene resin such that the proportion of the pressure-sensitive adhesive tape (1) was 5% by mass with respect to the polypropylene resin.

### (3-3) Preparation of Reproduced Plastic Material (3) and Molded Article (3) Using Pressure-Sensitive Adhesive Tape (2)

The pressure-sensitive adhesive tape (2) (from which the release liner was peeled off) was mixed with a polyethylene resin (SHC7260, manufactured by Braskem, softening point of 126° C., pellet) such that the proportion of the pressure-sensitive adhesive tape (2) was 1% by mass with respect to the polyethylene resin, and the mixture was melted and kneaded under conditions of 146° C., a kneading speed of 350 rpm, a screw rotation speed of 300 rpm, and a discharge speed of 5 kg/h using a twin-screw extruder (KZW25, manufactured by TECHNOVEL CORPORATION) heated to 146° C., thereby obtaining a pellet of the reproduced plastic material (3) containing 1% by mass of the pressure-sensitive adhesive tape (2).

A molded article (3) of a multipurpose test piece type A1 obtained in conformity with JIS K 7139 was prepared by using the pellet of the reproduced plastic material (3) obtained above in an injection molding machine (PNX60III, manufactured by NISSEI PLASTIC INDUSTRIAL CO., LTD., molding machine temperature: 146° C., mold temperature: 40° C.).

### (3-4) Preparation of Reproduced Plastic Material (4) and Molded Article (4) Using Pressure-Sensitive Adhesive Tape (2)

A molded article (4) of a multipurpose test piece type A1 obtained in conformity with JIS K 7139 was prepared by the same operation as in the preparation of the molded article (3) described in the section (3-3) except that the pressure-sensitive adhesive tape (2) (from which the release liner was peeled off) was mixed with the polyethylene resin such that the proportion of the pressure-sensitive adhesive tape (2) was 5% by mass with respect to the polyethylene resin.

### (Reference Example 1: Molded Article (C1) of Thermoplastic Resin (Polypropylene Resin))

A molded article (C1) of a multipurpose test piece type A1 obtained in conformity with JIS K 7139 was prepared by using a polypropylene resin (J106G, manufactured by Prime Polymer Co., Ltd., melting point of 160° C., pellet) in an injection molding machine (PNX60III, manufactured by NISSEI PLASTIC INDUSTRIAL CO., LTD., molding machine temperature: 180° C., mold temperature: 40° C.).

### Reference Example 2: Molded Article (C2) of Thermoplastic Resin (Polyethylene Resin)

A molded article (C2) of a multipurpose test piece type A1 obtained in conformity with JIS K 7139 was prepared by using a polyethylene resin (SHC7260, manufactured by Braskem, softening point of 126° C., pellet) in an injection molding machine (PNX60III, manufactured by NISSEI PLASTIC INDUSTRIAL CO., LTD., molding machine temperature: 146° C., mold temperature: 40° C.).

### 4. CALCULATION OF TENSILE STRENGTH RATIO (σ_{b}/σₐ) AND FLEXURAL STRENGTH RATIO (σ_{d}/σ_{c})

(4-1) Ratios of Tensile Strength Ratio (σ_{b}/σₐ) and Flexural Strength Ratio (σ_{d}/σ_{c})

The tensile strength (σ_{b}) and the flexural strength (σ_{d}) of each test piece were measured under the above-described conditions using the molded articles (1) to (4) of the multipurpose test piece type A1 obtained above as the test pieces. Similarly, the tensile strength (σₐ) and the flexural strength (σ_{c}) of the test piece of each thermoplastic resin were measured under the above-described conditions using the molded articles (C1) and the molded article (C2) described above as the test pieces.

Next, the ratios of the tensile strength ratio (σ_{b}/σₐ) and the flexural strength ratio (σ_{d}/σ_{c}) of the pressure-sensitive adhesive tapes (1) and (2) in Examples 1 and 2 were respectively calculated by substituting the obtained values into Expression (1) and Expression (2). The results are listed in Table 1.

$$tensile strength ratio ( {σ}_{b} / {σ}_{a} ) \qquad Expression ( 1 )$$

$$flexural strength ratio ( {σ}_{d} / {σ}_{c} ) \qquad Expression ( 2 )$$

The properties of the reproduced plastic materials (1) to (4) and the molded articles (1) to (4) prepared by using the pressure-sensitive adhesive tapes (1) and (2) in Examples 1 and 2, the properties of the molded articles in Reference Examples (1) and (2), and the ratios of the tensile strength ratio (σ_{b}/σₐ) and the flexural strength ratio (σ_{d}/σ_{c}) are listed in Table 2.

TABLE 2

| | | Molded | Molded | Molded | Molded | Reference | Reference |
|---|---|---|---|---|---|---|---|
| | | article (1) | article (2) | article (3) | article (4) | Example (1) | Example (2) |
| Properties | Thermoplastic | PP | PP | PE | PE | PP | PE |
| of molded | resin in | | | | | | |
| article | adherend | | | | | | |
| | (resin mixed | | | | | | |
| | with pressure- | | | | | | |
| | sensitive | | | | | | |
| | adhesive tape) | | | | | | |
| | Content of | 1.0 | 5.0 | 1.0 | 5.0 | 0 | 0 |
| | pressure- | | | | | | |
| | sensitive | | | | | | |
| | adhesive tape | | | | | | |
| | [mass %] | | | | | | |
| | Content of | 99.0 | 95.0 | 99.0 | 95.0 | 100 | 100 |
| | polyolefin [%] | | | | | | |
| | Tensile strength | 35.9 | 34.8 | 25.1 | 24.6 | 37.4 | 25.9 |
| | [MPa] | | | | | | |
| | Tensile strain at | 24 | 24 | 264 | 89 | 24 | 341 |
| | strength [%] | | | | | | |
| | Flexural | 51.5 | 51.6 | 5.2 | 5.3 | 54.8 | 5.1 |
| | strength [MPa] | | | | | | |
| | Flexural strain | 5.1 | 5.1 | 24.5 | 23.5 | 5.0 | 26.3 |
| | at flexural | | | | | | |
| | strength [%] | | | | | | |
| | Dispersion state | Satisfactory | Satisfactory | Satisfactory | Satisfactory | — | — |
| | Ratio of tensile | 0.96 | 0.93 | 0.97 | 0.95 | 1.00 | 1.00 |
| | strength | | | | | | |
| | Ratio of flexural | 0.94 | 0.94 | 1.03 | 1.04 | 1.00 | 1.00 |
| | strength | | | | | | |
| | Approximate | 95.94 | 92.49 | 96.69 | 94.62 | | |
| | rate of tensile | | | | | | |
| | strength after | | | | | | |
| | recycling (%) | | | | | | |
| | Approximate | 93.7 | 93.9 | 103.1 | 104.0 | | |
| | rate of flexural | | | | | | |
| | strength after | | | | | | |
| | recycling (%) | | | | | | |

| | | |
|---|---|---|
| Remarks | Only PP | Only PE |

| | |
|---|---|
| resin | resin |

As shown in the experimental results in Tables 1 and 2, it was confirmed that the approximation rates between the tensile strengths and the flexural strengths “=(difference between tensile strengths and flexural strengths before and after recycling/tensile strength and flexural strength after recycling)×100” of the recycled products using the pressure-sensitive adhesive tapes in Examples 1 and 2 were 92% or greater. Therefore, it was confirmed that the pressure-sensitive adhesive tapes of the examples can be recycled in a state of being attached to the adherend containing a thermoplastic resin and that the approximation rates between the tensile strengths and the flexural strengths of the reproduced plastic material after the pressure-sensitive adhesive tape was recycled were small.

According to the present disclosure, it is possible to provide a pressure-sensitive adhesive tape that can be recycled in a state of being attached to an adherend containing a thermoplastic resin and that has a small rate of a decrease in tensile strength of a reproduced plastic material after the pressure-sensitive adhesive tape is recycled.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. A recyclable pressure-sensitive adhesive tape comprising:
a base material; and
a pressure-sensitive adhesive layer laminated on at least one surface of the base material,
wherein:
the pressure-sensitive adhesive tape comprises 5% by mass or greater and 95% by mass or less of an olefin-based resin having an olefin-based monomer unit with respect to a total amount (100% by mass) of the pressure-sensitive adhesive tape; and
the pressure-sensitive adhesive tape satisfies Relational Formula (1):
$$0.8 \leq {σ}_{b} / {σ}_{a} \leq 1.2 , \qquad ( 1 )$$
where:
σₐ represents a tensile strength of a thermoplastic resin, and σ_{b} represents a tensile strength of a test piece, and
the test piece is prepared by:
mixing the pressure-sensitive adhesive tape and the thermoplastic resin to produce a mixture;
heating the mixture at a temperature 20° C. above a melting point of the thermoplastic resin;
preparing a resin pellet of the mixture with a twin-screw extruder under conditions of a kneading speed of 350 rpm, a screw rotation speed of 300 rpm and a discharge speed of 5 kg/h; and
obtaining the test piece, in conformity with JIS K 7139 multipurpose test piece type A, from the resin pellet by using an injection molding machine.

2. The recyclable pressure-sensitive adhesive tape according to claim 1,
wherein the pressure-sensitive adhesive tape further satisfies Relational Formula (2),
$$0.8 \leq {σ}_{d} / {σ}_{c} \leq 1.2 \qquad ( 2 )$$
where σ_{c} represents a flexural strength of the thermoplastic resin, and σ_{d} represents a flexural strength of the test piece.

3. The recyclable pressure-sensitive adhesive tape according to claim 1,
wherein the base material comprises a same resin as the thermoplastic resin, or a resin having a same chemical structure as a chemical structure of a main chain of the thermoplastic resin.

4. The recyclable pressure-sensitive adhesive tape according to claim 1,
wherein the base material comprises the olefin-based resin.

5. The recyclable pressure-sensitive adhesive tape according to claim 4,
wherein the olefin-based resin comprises a polyethylene resin or a polypropylene resin.

6. The recyclable pressure-sensitive adhesive tape according to claim 1,
wherein the base material is a foam base material.

7. The recyclable pressure-sensitive adhesive tape according to claim 1,
wherein the pressure-sensitive adhesive layer comprises an acrylic pressure-sensitive adhesive.

8. The recyclable pressure-sensitive adhesive tape according to claim 1,
wherein the thermoplastic resin comprises an olefin-based resin.

9. The recyclable pressure-sensitive adhesive tape according to claim 8,
wherein the olefin-based resin comprises a polyethylene resin or a polypropylene resin.

10. The recyclable pressure-sensitive adhesive tape according to claim 1,
wherein a content of the pressure-sensitive adhesive tape contained in the mixture is 10% by mass or less with respect to a total amount of the mixture.

11. The recyclable pressure-sensitive adhesive tape according to claim 1,
wherein the pressure-sensitive adhesive tape comprises one or two or more selected from the group consisting of an antioxidant, an ultraviolet absorbing agent, a heat stabilizer, and a resin reinforcing agent.

12. A component formed of:
the recyclable pressure-sensitive adhesive tape according to claim 1; and
a thermoplastic resin, to which the recyclable pressure-sensitive adhesive tape is attached.

13. An electronic equipment comprising the component according to claim 12.

14. A vehicle comprising the component according to claim 12.
